(19) United States
(12) Patent Application Publication
(10) Pub. No.: US 2018/0210420 A1
(43) Pub. Date: Jul. 26, 2018

(54) DISPLAY DEVICE AND DISPLAY METHOD

(71) Applicant: Mitsubishi Electric Corporation, Tokyo (JP)

(72) Inventors: Hiroki KANEKO, Tokyo (JP); Susumu MATSUBARA, Tokyo (JP); Kenji IRIGUCHI, Tokyo (JP); Nobuyuki TAKAHASHI, Tokyo (JP); Toshiyuki MORITA, Nagoya-shi (JP)

(73) Assignee: Mitsubishi Electric Corporation, Tokyo (JP)

(21) Appl. No.: 15/327,203

(22) PCT Filed: Jul. 23, 2014
(86) PCT No.: PCT/JP2014/003876

§ 371 Date: Jan. 18, 2017

(51) Int. Cl. G05B 19/4068; G05B 19/4069

(52) U.S. Cl. CPC G05B 19/4068; G05B 2219/35353; G05B 2219/35349; G05B 19/4069

(57) ABSTRACT

A display device and a display method to enable, by reducing the amount of data to be displayed, reduction of the time required for display even when the data to be dealt with is three-dimensional coordinate data are obtained.

A display device according to the invention includes a tool-movement-path calculation means 14 to calculate, on the basis of data of a machining program on which movement commands for a tool in a three-dimensional coordinate system are written, tool movement paths through which the tool moves in the three-dimensional coordinate system, a path-replacement-processing unit 19 to replace, on the basis of the tool movement paths calculated by the tool-movement-path calculation means 14 and a predetermined index, consecutive tool movement paths with a replacement path, and a display unit 20 to display the replacement path replaced by the path-replacement-processing unit 19.

### TECHNICAL FIELD

The present invention relates to a display device and a display method for a numerical control system that controls a machine tool to move a workpiece or a tool along a commanded path.

### BACKGROUND ART

A general numerical control system uses an NC machining program for controlling a machine tool to machine a workpiece with a tool. In such an NC machining program, movement commands for moving a workpiece or a tool along a predetermined path are written. In general, because it is difficult for an operator to check an NC machining program by looking at only data of the NC machining program, a general numerical control system converts movement commands written in the NC machining program into path information such as vector data or the like, and displays it on a display device such as a CRT and a liquid crystal monitor.

A conventional display device stores, as vertex coordinate data, coordinates of vertexes and the numbers of the vertexes indicating their connection orders, which are for configuring a polygon or a polyline made of consecutive line segments, searches the stored vertex coordinate data for necessary vertex coordinate data, and, on the basis of the retrieved vertex coordinate system, displays the line segments in a display unit.

When a view is reduced in the display unit, thinning-out processing is performed on overlapping vertexes and vertexes located in the middle of paths that can be regarded as a straight line; in other words, by processing such as exclusion and omission of vertex coordinates in accordance with the display scale, when a display scale is very small, the amount of data to be displayed is reduced to increase display speed (for example, refer to Patent Document 1).

### PRIOR ART DOCUMENT

### Patent Document

Patent Document 1; Japanese Unexamined Patent Application Publication No. 2000-276579 (Paragraphs 0007, 0009, 0019, 0021 and 0022, and FIGS. 5 through 8)

### SUMMARY OF INVENTION

### Technical Problem

In the conventional display device, the vertex coordinate data to be dealt with is two-dimensional coordinate data. Then, when the conventional display device displays three-dimensional coordinate data, the three-dimensional coordinate data must be converted into two-dimensional coordinate data before the thinning-out processing, resulting in a problem that it takes time to display.

The present invention is made to solve such a problem as mentioned above, and an objective is to obtain a display device and a display method that can reduce the time required for display even when the data to be dealt with is three-dimensional coordinate data.

### Solution to Problem

A display device according to the invention includes a tool-movement-path calculation means to calculate, on the basis of data of a machining program on which movement commands for a tool in a three-dimensional coordinate system are written, tool movement paths through which the tool moves in the three-dimensional coordinate system; a path-replacement-processing unit to replace, on the basis of the tool movement paths calculated by the tool-movement-path calculation means and a predetermined index, consecutive tool movement paths with a replacement path; and a display unit to display the replacement path replaced by the path-replacement-processing unit.

A display method according to the invention includes a tool-movement-path calculation step of calculating, on the basis of data of a machining program on which movement commands for a tool in a three-dimensional coordinate system are written, tool movement paths through which the tool moves in the three-dimensional coordinate system; a path replacement step of replacing, on the basis of the tool movement paths calculated in the tool-movement-path calculation step and a predetermined index, consecutive tool movement paths with a replacement path; and a replacement-path display step of displaying in a display unit the replacement path replaced in the path replacement step.

### Advantageous Effects of Invention

The invention provides a display device and a display method that enable reduction of the amount of data to be displayed even when the data to be dealt with is three-dimensional coordinate data, which leads to reduction of the time required for display.

### BRIEF DESCRIPTION OF DRAWINGS

FIG. 1 is a block diagram showing a configuration of a numerical control system according to Embodiment 1.

FIG. 2 is a flowchart showing a procedure for editing an NC machining program with replacement paths displayed in a display device of the numerical control system according to Embodiment 1.

FIG. 3 is a conceptual diagram showing a method of generating path approximation information according to Embodiment 1.

FIG. 4 is a conceptual diagram showing a method of replacing consecutive tool movement paths with an approximation path in path replacement processing according to Embodiment 1.

FIG. 5 is a conceptual diagram showing a method of extracting tool movement paths to be displayed in a configuration display unit on the basis of an approximation path in the path replacement processing according to Embodiment 1.

FIG. 6 is a conceptual diagram showing a method of replacing extracted tool movement paths with replacement paths in the path replacement processing according to Embodiment 1.

FIG. 7 is a conceptual diagram showing a method of replacing extracted tool movement paths with replacement paths in the path replacement processing according to Embodiment 1 applying another display magnification.

FIG. 8 is a perspective view showing an entire set of replacement paths displayed in a configuration display unit according to Embodiment 1.

FIG. 9 is a block diagram showing a configuration of a numerical control system according to Embodiment 2.

FIG. 10 is a flowchart showing a procedure for editing an NC machining program with replacement paths displayed in a display device of the numerical control system according to Embodiment 2.

FIG. 11 is a perspective view showing a three-dimensional space that is displayed in a configuration display unit according to Embodiment 2.

FIG. 12 is a block diagram showing a configuration of a numerical control system according to Embodiment 3.

FIG. 13 is a flowchart showing a procedure for editing an NC machining program with replacement paths displayed in a display device of the numerical control system according to Embodiment 3.

FIG. 14 is a conceptual diagram showing a method of generating path shade information according to Embodiment 3.

FIG. 15 is a block diagram showing a configuration of a numerical control system according to Embodiment 4.

FIG. 16 is a flowchart showing a procedure for editing an NC machining program with replacement paths displayed in a display device of the numerical control system according to Embodiment 4.

FIG. 17 is a conceptual diagram showing a method of calculating position information in the NC machining program according to Embodiment 4.

FIG. 18 is a diagram showing display screens of a display unit according to Embodiment 4.

FIG. 19 is a block diagram showing a configuration of a numerical control system according to Embodiment 5.

FIG. 20 is a flowchart showing a procedure for editing an NC machining program with replacement paths displayed in a display device of the numerical control system according to Embodiment 5.

FIG. 21 is a conceptual diagram showing a method of generating process information by dividing the NC machining program according to Embodiment 5 into arbitrary processes.

FIG. 22 is a diagram showing display screens of a display unit according to Embodiment 5.

### DESCRIPTION OF EMBODIMENTS

### Embodiment 1

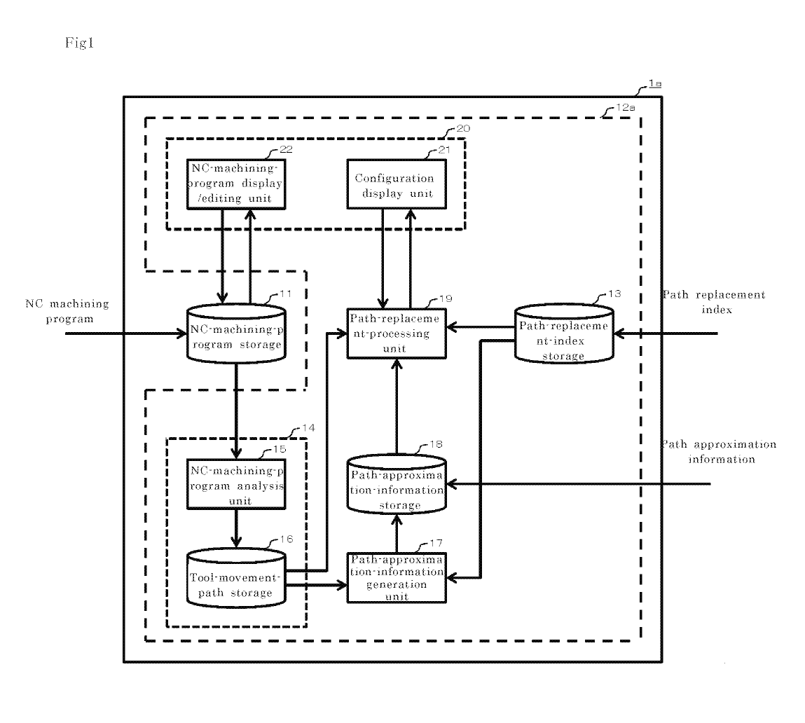

FIG. 1 is a block diagram showing a configuration of a numerical control system according to Embodiment 1. Referring to FIG. 1, a numerical control system provided with a display device according to Embodiment 1 is explained.

A numerical control system 1a according to Embodiment 1 includes an NC-machining-program storage 11 and a display device 12a. The NC-machining-program storage 11 stores an NC machining program inputted from the outside of the numerical control system 1a. In the NC machining program, such as movement commands for moving a workpiece or a tool for machining the workpiece along a predetermined path in a three-dimensional coordinate system, auxiliary operation commands for a machine tool, and values set as machining conditions are written. The NC machining program is created by commercially available CAM software or the like, and written in character strings such as macro statements and so-called G-codes, which conform to a format such as EIA and ISO.

A display device 12a includes a path-replacement-index storage 13, a tool-movement-path calculation means 14, a path-approximation-information generation unit 17, a path-approximation-information storage 18, path-replacement-processing unit 19, and a display unit 20.

The path-replacement-index storage 13 stores a path replacement index, which will be described later, inputted from the outside of the numerical control system 1a.

The tool-movement-path calculation means 14 acquires from the NC-machining-program storage 11 a machining program on which movement commands for a tool in the three-dimensional coordinate system are written, and calculates tool movement paths through which the tool moves in the three-dimensional coordinate system on the basis of data of the acquired NC machining program.

In more detail, the tool-movement-path calculation means 14 includes an NC-machining-program analysis unit 15 and a tool-movement-path storage 16. The NC-machining-program analysis unit 15 analyzes the NC machining program acquired from the NC-machining-program storage 11, and calculates the tool movement paths in accordance with the tool movement commands written in the NC machining program. The tool-movement-path storage 16 stores the tool movement paths inputted from the NC-machining-program analysis unit 15.

The path-approximation-information generation unit 17 acquires the tool movement paths from the tool-movement-path storage 16, acquires a path replacement index from the path-replacement-index storage 13, and generates path approximation information, which will be described later, on the basis of the acquired tool movement paths and the path replacement index. The path-approximation-information storage 18 stores the path approximation information inputted from the path-approximation-information generation unit 17.

The path-replacement-processing unit 19 acquires tool movement paths from the tool-movement-path storage 16, acquires the path approximation information from path-approximation-information storage 18, acquires a path replacement index from the path-replacement-index storage 13, and acquires, from a configuration display unit 21, which will be described later, a current display area and a current display magnification at the time when the configuration display unit 21 displays a replacement path. The path-replacement-processing unit 19 performs path replacement processing for replacing consecutive tool movement paths with a replacement path on the basis of the acquired tool movement paths, path approximation information, path replacement index, display area, and display magnification. Details of the path replacement processing will be described later.

The display unit 20 displays replacement paths acquired from the path-replacement-processing unit 19.

In more detail, the display unit 20 includes the configuration display unit 21 and an NC-machining-program display/editing unit 22. The configuration display unit 21 includes a display screen such as a liquid crystal display, arranges replacement paths acquired from the path-replacement-processing unit 19 in a display area in a three-dimensional space, and displays replacement paths to be displayed on the display screen. The display magnification at the time of displaying replacement paths and the like is set in the configuration display unit 21.

The NC-machining-program display/editing unit 22 includes a display screen such as a liquid crystal display, displays on the display screen the data of the NC machining program acquired from the NC-machining-program storage 11, and waits until an editing command (not illustrated) for the NC machining program is inputted.

When the editing command for the NC machining program is inputted, the NC-machining-program display/editing unit 22 edits the data of the NC machining program in accordance with the editing command for the NC machining program, and stores the edited NC machining program in the NC-machining-program storage 11. The NC-machining-program display/editing unit 22 displays on the display screen the edited data of the NC machining program acquired from the NC-machining-program storage 11.

Note that, the configuration display unit 21 and the NC-machining-program display/editing unit 22 do not need to have a display screen for each, but they may share one display as a display unit 20.

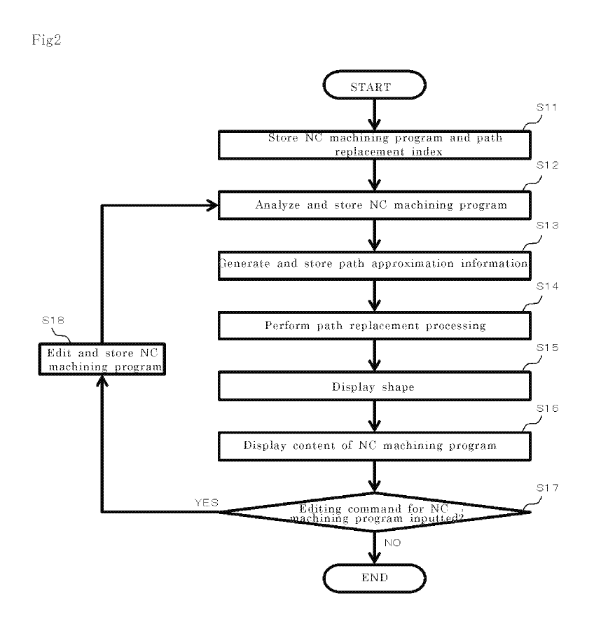

FIG. 2 is, in the display device of the numerical control system according to Embodiment 1, a flowchart showing a procedure for editing an NC machining program with replacement paths displayed. Referring to FIG. 2, a method of displaying replacement paths and editing an NC machining program by the display device 12a of the numerical control system 1a according to Embodiment 1 is explained.

In Step S11 in FIG. 2, the NC-machining-program storage 11 stores an NC machining program inputted from the outside of the numerical control system 1a, and the path-replacement-index storage 13 stores a path replacement index inputted from the outside of the numerical control system 1a.

Here, the path replacement index is explained. The path replacement index is, when path replacement processing for replacing tool movement paths with a replacement path is performed, a basic reference value for determining whether to replace the tool movement paths. In Embodiment 1, path replacement indexes are defined as t_{base} and θ_{base}; where, in regard to two consecutive tool movement paths, t_{base} is the shortest distance between the end point of the second tool movement path and a line virtually extending the first tool movement path in its moving direction (hereafter, referred to as a replacement-distance-index); and θ_{base} is an angle between the two consecutive tool movement paths (hereafter, referred to as a replacement-angle-index). Note that, the path replacement indexes are not limited to the replacement-distance-index and the replacement-angle-index. For example, the path replacement index may be either one of the replacement-distance-index and the replacement-angle-index, the length of a line segment from the start point to the end point of a tool movement path, a tool feeding speed that is one of the values set as machining conditions, or the like.

In Step S12 in FIG. 2, the NC-machining-program analysis unit 15 analyzes an NC machining program acquired from the NC-machining-program storage 11, and calculates, in accordance with tool movement commands written in the NC machining program in the three-dimensional coordinate system, tool movement paths in the three-dimensional coordinate system. In Step S12, the tool-movement-path storage 16 stores the tool movement paths inputted from the NC-machining-program analysis unit 15.

In Step S13, the path-approximation-information generation unit 17 acquires tool movement paths from the tool-movement-path storage 16, acquires path replacement indexes from the path-replacement-index storage 13, and generates path approximation information on the basis of the acquired tool movement paths and path replacement indexes. Here, the path approximation information is information for approximating multiple tool movement paths as a single approximation path. Each tool movement path is determined, on the basis of the approximation path, whether it is a path to be displayed in the display unit 20.

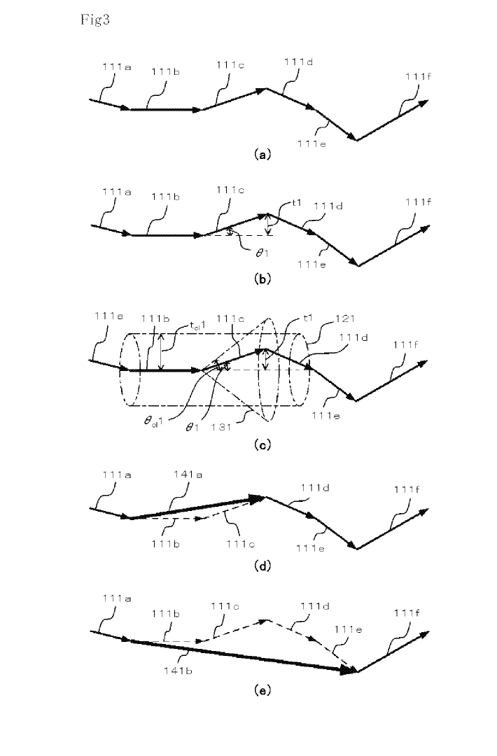

FIG. 3 is a conceptual diagram showing a method of generating path approximation information in Embodiment 1. Referring to FIG. 3, a method of generating path approximation information by the path-approximation-information generation unit 17 according to Embodiment 1 is explained.

In FIG. 3(a), tool movement paths 111a, 111b, 111c, 111d, 111e, and 111f are six consecutive tool movement paths, which are included in tool movement paths acquired by the path-approximation-information generation unit 17. The path-approximation-information generation unit 17 arranges the tool movement paths 111a, 111b, 111c, 111d, 111e, and 111f in the three-dimensional space.

In FIG. 3(b), the path-approximation-information generation unit 17 calculates a distance t1 and an angle θ1. The distance t1 is, with respect to the two consecutive tool movement paths 111b and 111c, the shortest distance between the end point of the second tool movement path 111c and a line virtually extending the first tool movement path 111b in its moving direction. The angle θ1 is an angle between the two consecutive tool movement paths 111b and 111c.

Then, the path-approximation-information generation unit 17 calculates an approximation-critical-distance t_{cl}1 and an approximation-critical-angle θ_{cl}1 on the basis of the path replacement indexes. The approximation-critical-distance t_{cl}1 is obtained by multiplying the replacement-distance-index t_{base} acquired from the path-replacement-index storage 13 by an arbitrary coefficient a1. The approximation-critical-angle θ_{cl}1 is obtained by multiplying the replacement-angle-index θ_{base} acquired from the path-replacement-index storage 13 by an arbitrary coefficient b1. The approximation-critical-distance t_{cl}1 and the approximation-critical-angle θ_{cl}1 are expressed by the following Formula 1 and Formula 2 respectively.

[Expression 1]

t_{cl}1=a1×t_{base} (Formula 1)

[Expression 2]

θ_{cl}1=b1×θ_{base} (Formula 2)

In Embodiment 1, the coefficients a1 and b1 are calculated in advance in accordance with an initial display magnification at the time of displaying replacement paths in the configuration display unit 21. For example, the coefficients a1 and b1 are calculated in advance in accordance with the display magnification with which all replacement paths can be displayed just fitting in the display area of the configuration display unit 21 when the configuration display unit 21 displays the replacement paths. The coefficients a1 and b1 are calculated, for example, as real numbers. The path-approximation-information generation unit 17 accordingly calculates the coefficients a1 and b1 in accordance with the above-mentioned display magnification or the like.

The coefficients a1 and b1, for example, may be given in association with the replacement-distance-index t_{base} and the replacement-angle-index θ_{base}, and stored in the path-replacement-index storage 17 in advance. The coefficients a1 and b1 do not need to be the same value.

In FIG. 3(c), the path-approximation-information generation unit 17 calculates a virtual cylinder 121 and a virtual cone 131, and arranges them in the three-dimensional space where the tool movement paths are arranged. The virtual cylinder 121 is a cylinder defined by the tool movement path 111b and a line virtually extending the tool movement path 111b in its moving direction as a central axis, and the approximation-critical-distance t_{cl}1 as a radius. The virtual cone 131 is a cone defined by the end point of the tool movement path 111b as an apex, a virtual line extending the tool movement path 111b in its moving direction as a center line, and the approximation-critical-angle θ_{cl}1 as an angle between the central axis and the generating line.

The path-approximation-information generation unit 17 determines, when disposing the virtual cylinder 121 and the virtual cone 131, whether the end point of the tool movement path 111c is positioned inside the virtual cylinder 121 and the line virtually extending the tool movement path 111c in its moving direction intersects with the base of the virtual cone 131.

Note that, the case where the end point of the tool movement path 111c is positioned inside the virtual cylinder 121 and the line virtually extending the tool movement path 111c in its moving direction intersects with the base of the virtual cone 131 is, namely, the case where the distance t1 is not larger than the approximation-critical-distance t_{cl}1 and the angle θ1 is not larger than the approximation-critical-angle θ_{cl}1. In this case, conditions for the distance t1 and the angle θ1 are expressed by the following Formula 3 and Formula 4 respectively.

[Expression 3]

t1≤t_{cl}1 (Formula 3)

[Expression 4]

θ1≤θ_{cl}1 (Formula 4)

In the case of FIG. 3(c), because the distance t1 and the angle θ1 satisfy Formula 3 and Formula 4, the path-approximation-information generation unit 17 replaces, as shown in FIG. 3(d), the two consecutive tool movement paths 111b and 111c with an approximation path 141a that is a path being a line segment connecting the start point of the first tool movement path 111b to the end point of the second tool movement path 111c.

The path-approximation-information generation unit 17 repeats operations similar to FIGS. 3(b), 3(c) and 3(d) on the six consecutive tool movement paths 111a, 111b, 111c, 111d, 111e and 111f. For example, the path-approximation-information generation unit 17 repeats the above-mentioned operations on the approximation path 141a and the tool movement path 111d to replace the approximation path 141a and the tool movement path 111d with an approximation path. Then, the above-mentioned operations are also repeated on the approximation path that has replaced the approximation path 141a and the tool movement path 111d, and on the tool movement path 111e, to replace the approximation path that has replaced the approximation path 141a and the tool movement path 111d, and the tool movement path 111e, with an approximation path. As a result, as shown in FIG. 3(e), the path-approximation-information generation unit 17 replaces the consecutive tool movement paths 111b, 111c, 111d, and 111e with an approximation path 141b.

Note that, to replace the tool movement paths 111a, 111b, 111c, 111d, 111e, and 111f with the approximation path 141b, the path-approximation-information generation unit 17 may replace the tool movement path 111b and the tool movement path 111c with the approximation path 141a, then repeat the above-mentioned operations on the tool movement path 111d and the tool movement path 111e to replace them with an approximation path, and furthermore repeat the above-mentioned operations on the approximation path 141a and the approximation path that has replaced the tool movement paths 111d and 111e to replace them with the approximation path 141b.

In this way, the path-approximation-information generation unit 17 generates path approximation information indicating that the tool movement paths 111b, 111c, 111d, and 111e are replaced with the approximation path 141b. The path approximation information is, for example, information including information on connection order indicating that the end point of the tool movement path 111a is next connected to the start point of the tool movement path 111f, and accompanied by the approximation-critical-distance t_{cl}1 at that time. In other words, the path approximation information indicates that if conditions on the approximation-critical-distance t_{cl}1 and the approximation-critical-angle θ_{cl}1 are given, the tool movement paths 111b, 111c, 111d, and 111e can be omitted by being replaced with one path, the approximation path 141b.

The path-approximation-information generation unit 17 repeats the above operations on all of the acquired tool movement paths to generate the path approximation information for all of the tool movement paths.

Note that, the path-approximation-information generation unit 17 may use only the replacement-distance-index t_{base} as a path replacement index. In the case, the path-approximation-information generation unit 17 calculates the approximation-critical-distance t_{cl}1 by multiplying the replacement-distance-index t_{base} by the coefficient b1, calculates a virtual cylinder to be arranged in the three-dimensional space where the tool movement paths are arranged, and determines whether to replace consecutive tool movement paths with an approximation path by checking that the distance t1 satisfies the above-mentioned Formula 4, to generate path approximation information.

Alternatively, the path-approximation-information generation unit 17 may use only the replacement-angle-index θ_{base} as a path replacement index. In the case, the path-approximation-information generation unit 17 calculates the approximation-critical-angle θ_{cl}1 by multiplying the replacement-angle-index θ_{base} by the coefficient a1, calculates a virtual cone to be arranged in the three-dimensional space where the tool movement paths are arranged, and determines whether to replace the consecutive tool movement paths with an approximation path by checking the angle θ1 satisfies the above-mentioned Formula 3, to generate path approximation information.

The above is the explanation of the method of generating the path approximation information by the path-approximation-information generation unit 17 in Step S13 in FIG. 2.

Returning to the flowchart in FIG. 2; in Step S13, the path-approximation-information storage 18 stores the path approximation information inputted from the path-approximation-information generation unit 17.

In Step S14, the path-replacement-processing unit 19 acquires tool movement paths from the tool-movement-path storage 16, path approximation information from the path-approximation-information storage 18, path replacement indexes from the path-replacement-index storage 13, and from the configuration display unit 21, the current display area and the current display magnification at the time when the configuration display unit 21 displays a replacement path. The path-replacement-processing unit 19 performs path replacement processing for replacing consecutive multiple tool movement paths with one replacement path on the basis of the tool movement paths, the path approximation information, the path replacement indexes, the display area, and the display magnification, which have been acquired.

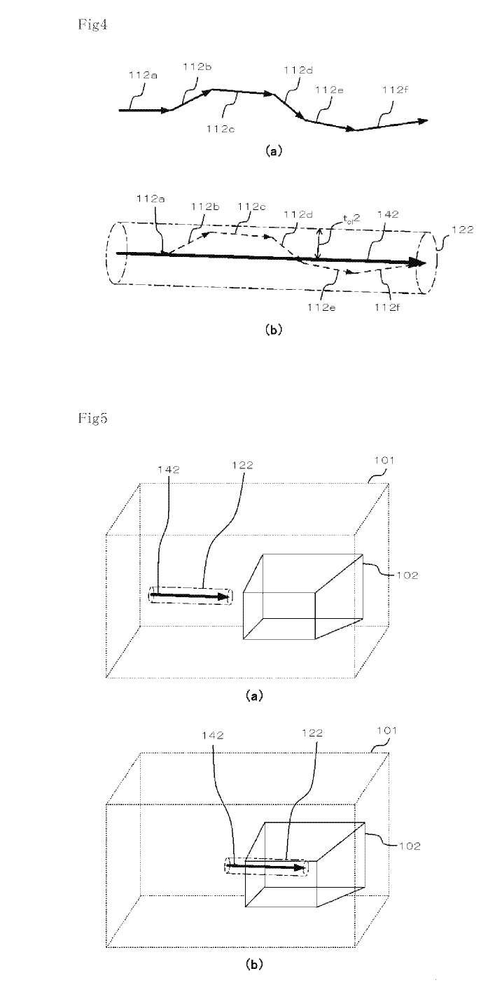

A method of performing the path replacement processing by the path-replacement-processing unit 19 is explained below referring to FIGS. 4, 5 and 6.

FIG. 4 is a conceptual diagram showing a method of replacing consecutive tool movement paths with an approximation path in the path replacement processing. In FIG. 4, the path-replacement-processing unit 19 replaces consecutive tool movement paths with an approximation path on the basis of the path approximation information acquired from path-approximation-information storage 18.

In FIG. 4(a), tool movement paths 112a, 112b, 112c, 112d, 112e, and 112f are six consecutive tool movement paths included in tool movement paths acquired by the path-replacement-processing unit 19. The path-replacement-processing unit 19 arranges the tool movement paths 112a, 112b, 112c, 112d, 112e, and 112f in a three-dimensional space.

Here, a case is considered where the path-replacement-processing unit 19 acquires path approximation information that includes information of connection order from the start point of the tool movement path 112a to the end point of the tool movement path 112f, and an approximation-critical-distance being t_{cl}2. In this case, the path-replacement-processing unit 19 calculates an approximation path 142 and a virtual cylinder 122 shown in FIG. 4(b) on the basis of the acquired path approximation information.

The approximation path 142 is a path made of a line segment connecting the start point of the tool movement path 112a and the end point of the tool movement path 112f. The path-replacement-processing unit 19 replaces, as shown in FIG. 4(b), the six consecutive tool movement paths 112a, 112b, 112c, 112d, 112e, and 112f with the approximation path 142. The virtual cylinder 122 is a cylinder defined by the central axis being the approximation path 142, and the radius being the approximation-critical-distance t_{cl}2.

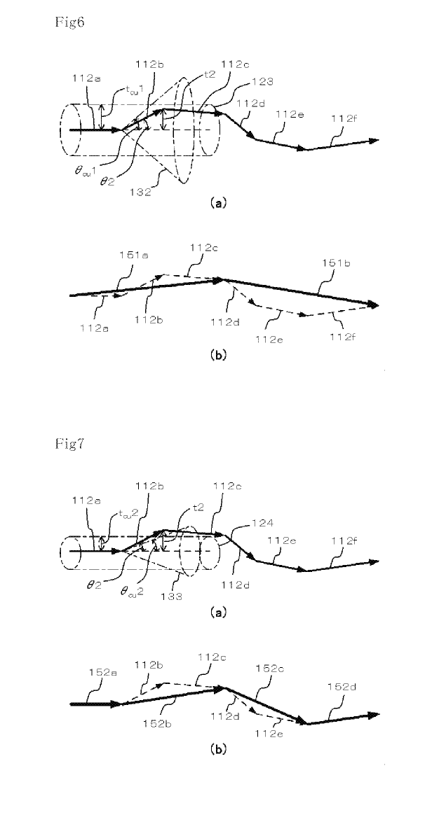

FIG. 5 is, in the path replacement processing, a conceptual diagram showing a method of extracting tool movement paths to be displayed in the configuration display unit 21 on the basis of an approximation path.

In FIG. 5, the path-replacement-processing unit 19 virtually arranges the calculated approximation path 142 and the virtual cylinder 122 in a three-dimensional space 101 of the configuration display unit 21. The path-replacement-processing unit 19 determines whether the tool movement paths 112a, 112b, 112c, 112d, 112e, and 112f, which are the tool movement paths before being replaced with the approximation path 142, are the paths to be displayed in the configuration display unit 21, on the basis of the virtual cylinder 122 and a current display area 102 at the time when the configuration display unit 21 displays replacement paths. This determination is made, when the virtual cylinder 122 is virtually arranged in the three-dimensional space 101 of the configuration display unit 21, by judgement of whether at least a part of the virtual cylinder 122 is included in the current display area 102 acquired from the configuration display unit 21.

As shown in FIG. 5(a), when the virtual cylinder 122 is virtually arranged in the three-dimensional space 101 of the configuration display unit 21, if no portion of the virtual cylinder 122 is included in the current display area 102, the path-replacement-processing unit 19 determines that the tool movement paths 112a, 112b, 112c, 112d, 112e, and 112f, which are the tool movement paths before being replaced with the approximation path 142, are not the tool movement paths to be displayed in the configuration display unit 21. If it is determined that the tool movement paths, namely, 112a and the others, are not the tool movement paths to be displayed, the path-replacement-processing unit 19 generates an approximation path and a virtual cylinder with respect to the consecutive tool movement paths following the tool movement path 112f, and repeats the above-mentioned operations.

On the other hand, as shown in FIG. 5(b), when the virtual cylinder 122 is virtually arranged in the three-dimensional space 101 of the configuration display unit 21, if at least a portion of the virtual cylinder 122 is included in the current display area 102, the path-replacement-processing unit 19 determines that the tool movement paths 112a, 112b, 112c, 112d, 112e, and 112f, which are the tool movement paths before being replaced with the approximation path 142, are the tool movement paths to be displayed in the configuration display unit 21. If it is determined that the tool movement paths, namely, 112a and the others, are the tool movement paths to be displayed, the path-replacement-processing unit 19 determines whether to replace the tool movement paths with a replacement path.

In this way, the path-replacement-processing unit 19 extracts an approximation path that the configuration display unit 21 needs to display from the approximation paths that have been replaced on the basis of the path approximation information, and extracts tool movement paths before being replaced with the extracted approximation path as the tool movement paths to be displayed in the configuration display unit 21.

Note that, the path-replacement-processing unit 19 repeats, before determining whether to replace tool movement paths with replacement paths to be described below, the above-mentioned operations on all of the tool movement paths by generating approximation paths and virtual cylinders, and extracts tool movement paths to be displayed in the configuration display unit 21.

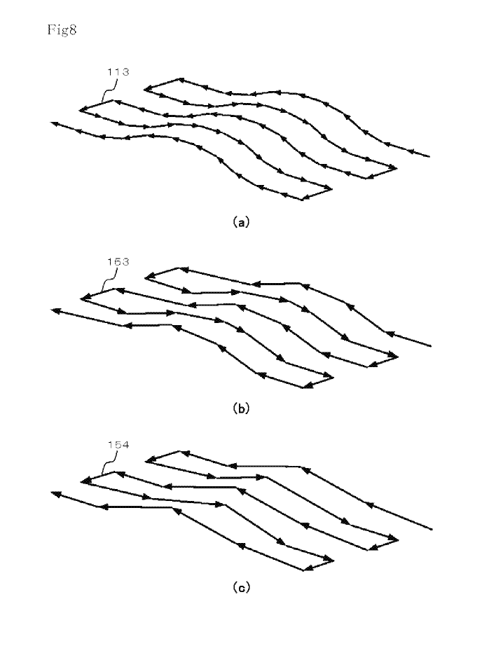

FIG. 6 is a conceptual diagram showing a method of replacing extracted tool movement paths with replacement paths in the path replacement processing. In FIG. 6, the path-replacement-processing unit 19 replaces the tool movement paths extracted as the tool movement paths to be displayed in the configuration display unit 21 with replacement paths. Here, a case is considered where a current display magnification acquired by the path-replacement-processing unit 19 is SC1.

In FIG. 6(a), the tool movement paths 112a, 112b, 112c, 112d, 112e, and 112f are six consecutive tool movement paths extracted as the tool movement paths to be displayed in the configuration display unit 21. The path-replacement-processing unit 19 arranges the tool movement paths 112a, 112b, 112c, 112d, 112e, and 112f in the three-dimensional space.

The path-replacement-processing unit 19 calculates a distance t2 and an angle θ2. The distance t2 is, with respect to the two consecutive tool movement paths 112a and 112b, the shortest distance between the end point of the second tool movement path 112b and the virtual line extending the first tool movement path 112a in its moving direction. The angle θ2 is an angle between the two consecutive tool movement paths 112a and 112b.

The path-replacement-processing unit 19 calculates a replacement-critical-distance t_{cu}1 and a replacement-critical-angle θ_{cu}1 on the basis of the path replacement indexes. The replacement-critical-distance t_{cu}1 is obtained by multiplying the replacement-distance-index t_{base} acquired from the path-replacement-index storage 13 by an arbitrary coefficient a2. The replacement-critical-angle θ_{cu}1 is obtained by multiplying the replacement-angle-index θ_{base} acquired from the path-replacement-index storage 13 by an arbitrary coefficient b2. The replacement-critical-distance t_{cu}1 and the replacement-critical-angle θ_{cu}1 are expressed by the following Formula 5 and Formula 6 respectively.

[Expression 5]

t_{cu}1=a2×t_{base} (Formula 5)

[Expression 6]

θ_{cu}1=b2×θ_{base} (Formula 6)

In Embodiment 1, the coefficients a2 and b2 are calculated on the basis of the acquired current display magnification SC1. A method of calculating the coefficients a2 and b2 are as follows.

In the path replacement processing, a range of the display magnification is defined in such a way that the value of display magnification is the maximum when all the replacement paths can be displayed just fitting in the display area 102 of the configuration display unit 21 at the time of the configuration display unit 21 displaying the replacement paths, and is 0 as the minimum value. The maximum values of the coefficients a2 and b2 are set to the coefficients a1 and b1 respectively, which are used for the path-approximation-information generation unit 17 to generate the path approximation information. The minimum value of each of the coefficients a2 and b2 is 0.

The coefficients a2 and b2 are each determined by interpolation within the range between the maximum value and the minimum value on the basis of the current display magnification SC1. The coefficients a2 and b2 are obtained, by interpolation, as smaller values when the configuration display unit 21 displays an enlarged view of replacement paths, and as larger values when the configuration display unit 21 displays a reduced view of replacement paths.

Note that, the method of interpolation, for example, may be linear interpolation, quadratic interpolation or higher order interpolation. The methods of calculating the coefficients a2 and b2 may be different from each other. The maximum values of the coefficients a2 and b2 may be dynamically changed in accordance with the stored NC machining program.

In FIG. 6(a), the path-replacement-processing unit 19 calculates a virtual cylinder 123 and a virtual cone 132, and arranges them in the three-dimensional space where tool movement paths are arranged. The virtual cylinder 123 is a cylinder defined by the tool movement path 112a and a line virtually extending the tool movement path 112a in its moving direction as a central axis, and the replacement-critical-distance t_{cu}1 as a radius. The virtual cone 132 is a cone defined by the end point of the tool movement path 112a as an apex, a line virtually extending the tool movement path 112a in its moving direction as a central axis, and the replacement-critical-angle θ_{cu}1 as an angle between the central axis and the generating line.

In FIG. 6(a), the path-replacement-processing unit 19 determines, when disposing the virtual cylinder 123 and the virtual cone 132, whether the end point of the tool movement path 112b is positioned inside the virtual cylinder 123 and the line virtually extending the tool movement path 112b in its moving direction intersects with the base of the virtual cone 132.

Note that, the case where the end point of the tool movement path 112b is positioned inside the virtual cylinder 123 and the line virtually extending the tool movement path 112b in its moving direction intersects with the base of the virtual cone 132 is, namely, the case where the distance t2 is not larger than the replacement-critical-distance t_{cu}1 and the angle θ2 is not larger than the replacement-critical-angle θ_{cu}1. In this case, conditions for the distance t2 and the angle θ2 are expressed by the following Formula 7 and Formula 8 respectively.

[Expression 7]

t2≤t_{cu}1 (Formula 7)

[Expression 8]

θ2≤θ_{cu}1 (Formula 7)

In the case of FIG. 6(a), because the distance t2 and the angle θ2 satisfy Formula 7 and Formula 8, the path-replacement-processing unit 19 replaces the two consecutive tool movement paths 112a and 112b with a replacement path that is a path made of a line segment connecting the start point of the first tool movement path 112a to the end point of the second tool movement path 112b.

The path-replacement-processing unit 19 repeats the above-mentioned operations on the six consecutive tool movement paths 112a, 112b, 112c, 112d, 112e, and 112f. When repeating the operations, the path-replacement-processing unit 19 repeats the above-mentioned operations on the replacement path that has replaced the tool movement paths 112a and 112b, and the tool movement path 112c, to replace the replacement path that has replaced the tool movement paths 112a and 112b, and the tool movement path 112c, with a replacement path 151a shown in FIG. 6(b).

Furthermore, the path-replacement-processing unit 19 repeats the above-mentioned operations on the replacement path 151a and the tool movement path 112d, and determines whether to replace the replacement path 151a and the tool movement path 112d with a replacement path. If it is determined that the replacement path 151a and the tool movement path 112d are not to be replaced with a replacement path, the path-replacement-processing unit 19 repeats the above-mentioned operations on the tool movement paths 112d and 112e, and replaces the tool movement paths 112d and 112e with a replacement path.

As a result, the path-replacement-processing unit 19 replaces, as shown in FIG. 6(b), the consecutive tool movement paths 112a, 112b, and 112c with the replacement path 151a, and replaces the consecutive tool movement paths 112d, 112e, and 112f with a replacement path 151b.

By repeating the above operations on all the acquired tool movement paths, the path-replacement-processing unit 19, in the case where the acquired current display magnification is SC1, performs the path replacement processing on all the tool movement paths, and replaces all the tool movement paths with replacement paths.

Note that, according to Formula 7 and Formula 8, if the values of the replacement-critical-distance t_{cu}1 and the replacement-critical-angle θ_{cu}1 are larger, the distance t2 and the angle θ2 are likely to satisfy Formula 7 and Formula 8. In this case, the number of times to determine that two consecutive tool movement paths should be replaced with a replacement path is larger. On the other hand, if the values of the replacement-critical-distance t_{cu}2 and the replacement-critical-angle θ_{cu}2 are smaller, the distance t2 and the angle θ2 are unlikely to satisfy Formula 7 and Formula 8. In this case, the number of times to determine that two consecutive tool movement paths should be replaced with a replacement path is smaller.

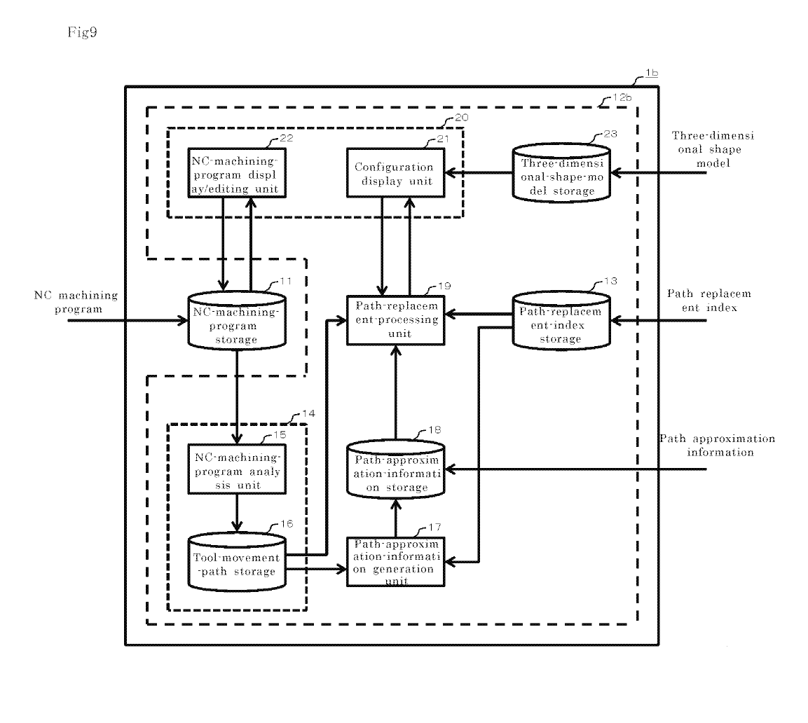

Next, a case is considered where the path-replacement-processing unit 19 acquires a display magnification different from the above-mentioned mentioned display magnification SC1. FIG. 7 is a conceptual diagram showing a method of replacing extracted tool movement paths with replacement paths in the path replacement processing according to Embodiment 1 applying another display magnification.

In FIG. 7, a case is considered where the current display magnification acquired by the path-replacement-processing unit 19 is a display magnification SC2 different from the display magnification SC1. Note that, the display magnification SC2 is, at the time the configuration display unit 21 displays replacement paths, a display magnification with which the replacement paths are displayed larger than with the display magnification SC1.

In FIG. 7(a), the path-replacement-processing unit 19 arranges the tool movement paths 112a, 112b, 112c, 112d, 112e, and 112f in the three-dimensional space, and calculates a distance t2 and an angle θ2.

The path-replacement-processing unit 19 calculates a replacement-critical-distance t_{cu}2 and a replacement-critical-angle θ_{cu}2 on the basis of the path replacement indexes. The replacement-critical-distance t_{cu}2 is obtained by multiplying the acquired replacement-distance-index t_{base} by an arbitrary coefficient a3, and the replacement-critical-angle θ_{cu}2 is obtained by multiplying the obtained replacement-angle-index θ_{base} by an arbitrary coefficient b3. The replacement-critical-distance t_{cu}2 and the replacement-critical-angle θ_{cu}2 are expressed by the following Formula 9 and Formula 10 respectively.

[Expression 9]

t_{cu}2=a3×t_{base} (Formula 9)

[Expression 10]

θ_{cu}2=b3×θ_{base} (Formula 10)

The coefficients a3 and b3 are calculated similarly to the case where the display magnification is SC1, on the basis of the acquired current display magnification SC2. The method of calculating the coefficients a3 and b3 is similar to the above-mentioned method of calculating a2 and b2, and the coefficients a3 and b3 are determined by interpolation within the range between the maximum and minimum values of the coefficients a3 and b3 on the basis of the current display magnification SC2.

Note that, the display magnification SC2 is, as described above, at the time the configuration display unit 21 displays replacement paths, a display magnification with which the replacement paths are displayed larger than with the display magnification SC1. As a result, the coefficients a3 and b3 are calculated as smaller values than the coefficients a2 and b3. In other words, the path-replacement-processing unit 19 calculates, on the basis of the acquired current display magnification SC2, the coefficients a3 and b3, comparing with the coefficients a2 and b2, as the values satisfying the following Formula 11 and Formula 12. In this case, the path-replacement-processing unit 19 calculates the replacement-critical-distance t_{cu}2 and the replacement-critical-angle θ_{cu}2 as smaller values than the replacement-critical-distance t_{cu}1 and the replacement-critical-angle θ_{cu}1.

[Expression 11]

a3<a2 (Formula 11)

[Expression 12]

b3<b2 (Formula 12)

In FIG. 7(a), the path-replacement-processing unit 19 calculates a virtual cylinder 124 and a virtual cone 133, and arranges them in the three-dimensional space where the tool movement paths are arranged. The virtual cylinder 124 is a cylinder defined by the tool movement path 112a and a line virtually extending the tool movement path 112a in its moving direction as a central axis, and the replacement-critical-distance t_{cu}2 as a radius. The virtual cone 133 is a cone defined by the end point of the tool movement path 112a as an apex, the line virtually extending the tool movement path 112a in its moving direction as a central axis, and the replacement-critical-angle θ_{cu}2 as an angle between the central axis and a generating line.

The path-replacement-processing unit 19 determines whether the end point of the tool movement path 112b is positioned inside the virtual cylinder 124, and a line virtually extending the tool movement path 112b in its moving direction intersects with the base of the virtual cone 133; that is to say, it determines whether the distance t2 is not larger than the replacement-critical-distance t_{cu}2, and the angle θ2 is not larger than the replacement-critical-angle θ_{cu}2. In this case, conditions for the distance t2 and the angle θ2 are expressed by the following Formula 13 and Formula 14 respectively.

[Expression 13]

t2≤t_{cu}2 (Formula 13)

[Expression 14]

θ2≤θ_{cu}2 (Formula 14)

As described above, the replacement-critical-distance t_{cu}2 and the replacement-critical-angle θ_{cu}2 are calculated as smaller values than the replacement-critical-distance t_{cu}1 and the replacement-critical-angle θ_{cu}1. In FIG. 7(a), because t2 is larger than the replacement-critical-distance t_{cu}2 and the angle θ2 is larger than the replacement-critical-angle θ_{cu}2, Formula 13 and Formula 14 are not satisfied.

Thus, when the display magnification is SC2, the path-replacement-processing unit 19 determines, different from when the display magnification is SC1, not to replace the two consecutive tool movement paths 112a and 112b with a replacement path. Instead, the path-replacement-processing unit 19 replaces the tool movement path 112a with a replacement path 152a. The path-replacement-processing unit 19, then repeats the above-mentioned operations on the tool movement paths 112b and 112c, and determines whether to replace them with a replacement path.

The path-replacement-processing unit 19 repeats the above-mentioned operations on the six consecutive tool movement paths 112a, 112b, 112c, 112d, 112e, and 112f. As a result, the path-replacement-processing unit 19 replaces, as shown in FIG. 7(b), the tool movement path 112a with the replacement path 152a, the consecutive tool movement paths 112b and 112c with a replacement path 152b, the consecutive tool movement paths 112d and 112e with a replacement path 152c, and the tool movement path 112f with a replacement path 152d.

By repeating the above operations on all the acquired tool movement paths, the path-replacement-processing unit 19, in the case where the acquired current display magnification is the display magnification SC2 that is different from SC1, performs the path replacement processing on all the tool movement paths, and replaces all the tool movement paths with replacement paths.

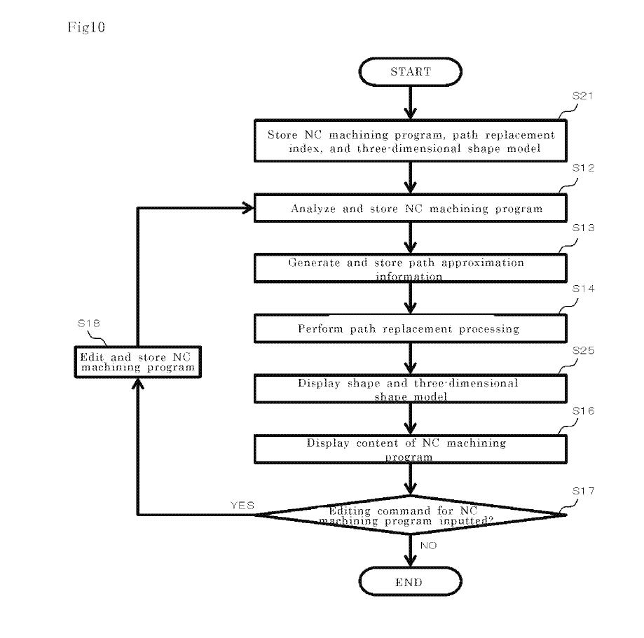

FIG. 8 is a perspective view showing an entire set of replacement paths displayed in the configuration display unit 21 according to Embodiment 1. FIG. 8(a) shows an entire set of tool movement paths before the path-replacement-processing unit 19 performs the path replacement processing. Tool movement paths 113 are tool movement paths that the path-replacement-processing unit 19 received from the tool-movement-path storage 16.

FIG. 8(b) shows an entire set of replacement paths obtained by the path replacement processing performed on the entire set of the tool movement paths shown in FIG. 8(a) by the path-replacement-processing unit 19 on the basis of the acquired display magnification SC3. In FIG. 8(b), replacement paths 153 are paths that have replaced the tool movement paths 113 by the path replacement processing performed by the path-replacement-processing unit 19 on the basis of the display magnification SC3. When the display magnification is SC3, as shown in FIG. 8(b), the number of replacement paths displayed in the configuration display unit 21 is smaller than the total number of original tool movement paths shown in FIG. 8(a).

FIG. 8(c) shows, when a display magnification acquired by the path-replacement-processing unit 19 is SC4, an entire set of replacement paths obtained by the path replacement processing performed on the entire set of the tool movement paths shown in FIG. 8(a). Replacement paths 154 in FIG. 8(c) are paths that have replaced the tool movement paths 113 by the path replacement processing performed by the path-replacement-processing unit 19 on the basis of the display magnification SC4.

Here, the display magnification SC4 is, when the configuration display unit 21 displays replacement paths, a display magnification with which the display replacement paths are displayed smaller than with the display magnification SC3. In this case, the replacement-critical-distance and the replacement-critical-angle are calculated, as described above, as larger values than the replacement-critical-distance and the replacement-critical-angle in the case where the display magnification is SC3. Thus, when the display magnification is SC4, the number of times to determine that two consecutive tool movement paths should be replaced with a replacement path is larger than when the display magnification is SC3.

As a result, when the display magnification SC4 is a display magnification with which replacement paths are displayed smaller than with the display magnification SC3, as shown in FIG. 8(c), the number of replacement paths shown in the configuration display unit 21 is, in comparison with the total number of original tool movement paths shown in FIG. 8(a), still smaller than with the display magnification SC3 shown in FIG. 8(b). In other words, when the display magnification is SC4, in comparison with the case when the display magnification is SC3, the number of displayed replacement paths is smaller; thus this prevents unclear separation of the lines representing the replacement paths. Thus, when a reduced view is displayed, grasp of the replacement paths displayed in the configuration display unit 21 is facilitated.

On the other hand, as described above, the display magnification SC3 is, when the configuration display unit 21 displays replacement paths, a display magnification applied to display more enlarged the replacement paths than those in the case where the display magnification SC4 is applied. In this case, the replacement-critical-distance and the replacement-critical-angle are calculated, as described above, as smaller values than the replacement-critical-distance and the replacement-critical-angle in the case where the display magnification is SC4. Thus, when the display magnification is SC3, the number of times to determine that two consecutive tool movement paths should be replaced with a replacement path is smaller than when the display magnification is SC4; thus, in FIG. 8(b), the number of replacement paths displayed in the configuration display unit 21 is larger than when the display magnification is SC4 shown in FIG. 8(c).

In other words, when the display magnification is SC3, the number of replacement paths displayed in the configuration display unit 21 is smaller than the total number of original tool movement paths shown in FIG. 8(a), and larger than when the display magnification is SC4. Thus, when an enlarged view is displayed, the replacement paths that are close to the original tool movement paths before the path replacement processing can be displayed.

Note that, in the above-mentioned operations, because the path replacement processing that multiplies the replacement-distance-index t_{base} and the replacement-angle-index θ_{base} by a real number 0 makes the replacement-critical-distance and the replacement-critical-angle 0 each, the replacement paths after the path replacement processing and the original tool movement paths before the path replacement processing are naturally identical. Thus, by enlarging the view, the original tool movement paths before the path replacement processing is performed can be displayed as well.

In this way, with the path replacement processing performed on the entire set of the tool movement paths by the path-replacement-processing unit 19 in accordance with the display magnification, the display device 12a can increase or decrease the number of replacement paths to be displayed in the configuration display unit 21; thus, this can shorten display time and facilitate grasp of displayed contents.

The above is the explanation of the path replacement processing in Step S14 in FIG. 2 according to Embodiment 1.

Returning to the flowchart in FIG. 2; in Step S15, the configuration display unit 21 acquires from the path-replacement-processing unit 19 replacement paths replaced by the above-mentioned path replacement processing, and arranges the acquired replacement paths in the three-dimensional space 101 and displays them on a display screen.

In Step S16, the NC-machining-program display/editing unit 22 displays data of an NC machining program acquired from the NC-machining-program storage 11 on the display screen, and enables input of an editing command for the NC machining program.

In Step S17, the NC-machining-program display/editing unit 22 monitors whether the NC machining program is edited. If an editing command for the NC machining program is inputted (YES in Step S17), in Step S18, the NC-machining-program display/editing unit 22 edits the data of the NC machining program in accordance with the editing command for the NC machining program, and stores the edited NC machining program in the NC-machining-program storage 11. Then, returning to Step S12 in FIG. 2, the above-described operations of Step S12 and thereafter are repeated.

On the other hand, in Step S17, if no editing command for the NC machining program is inputted but a command to end editing the NC machining program is inputted (NO in Step S17), the display device 12a in the numerical control system 1a according to Embodiment 1 displays the replacement paths and ends the processing of editing the NC machining program.

As explained in the above, the display device 12a includes the tool-movement-path calculation means 14, the path-replacement-processing unit 19, and the display unit 20, wherein the tool-movement-path calculation means 14 calculates, on the basis of the data of the NC machining program on which movement commands for a tool in a three-dimensional coordinate system are written, tool movement paths being paths through which the tool moves in the three-dimensional coordinate system; the path-replacement-processing unit 19 replaces, on the basis of the tool movement paths calculated by the tool-movement-path calculation means 14 and a predetermined index, consecutive tool movement paths with a replacement path; and the display unit displays the replacement path that is replaced by the path-replacement-processing unit 19.

As a result, the display device 12a can reduce the amount of data to be displayed even when the data to be dealt with is three-dimensional coordinate data, which leads to reduction of the time required for display.

As a predetermined index, the path-replacement-processing unit 19 uses, in regard to two consecutive tool movement paths calculated by the tool-movement-path calculation means 14, the shortest distance between the end point of the second tool movement path and a line virtually extending the first tool movement path in its moving direction. Alternatively, as a predetermined index, the path-replacement-processing unit 19 uses an angle between two consecutive tool movement paths, which is calculated by the tool-movement-path calculation means 14.

As a result, when displaying three-dimensional coordinate data, the display device 12a can reduce the amount of data to be displayed without converting the three-dimensional coordinate data into two-dimensional coordinate data, which leads to reduction of the time required for display.

In regard to two consecutive tool movement paths, if the shortest distance between the end point of the second tool movement path and a line virtually extending the first tool movement path in its moving direction is not longer than the distance predetermined in accordance with a display magnification regarding replacement paths to be displayed in the display unit 20, the path-replacement-processing unit 19 replaces the two consecutive tool movement paths with a replacement path. Alternatively, if an angle between two consecutive tool movement paths is not larger than the angle predetermined in accordance with the display magnification of replacement paths to be displayed in the display unit 20, the path-replacement-processing unit 19 replaces the two consecutive tool movement paths with a replacement path.

In other words, in the display device 12a, the path-replacement-processing unit 19 can increase or decrease the number of replacement paths to be displayed in the configuration display unit 21 by performing the path replacement processing in accordance with a display magnification. Thus, when a reduced view is displayed, unclear separation of lines representing the replacement paths can be prevented. Therefore, when a reduced view is displayed, replacement paths that are easy to grasp can be displayed, and when an enlarged view is displayed, replacement paths that are close to the original tool movement paths before the path replacement processing is performed can be displayed. Furthermore, by enlarging a view, the original tool movement paths before the path replacement processing is performed can be displayed as well. This leads to an effect that an operation of checking and editing data of the NC machining program by an operator is made easier.

The path-replacement-processing unit 19 replaces, on the basis of tool movement paths calculated by the tool-movement-path calculation means 14 and a distance or an angle predetermined in accordance with a display magnification different from a display magnification regarding replacement paths to be displayed in the display unit 20, consecutive tool movement paths with an approximation path, extracts, from replaced approximation paths, approximation paths that the display unit 20 needs to display, and replaces, with respect to the tool movement paths before being replaced with the extracted approximation paths, consecutive tool movement paths with a replacement path on the basis of a predetermined index. If an approximation path replaced on the basis of a distance or an angle predetermined in accordance with a display magnification different from the display magnification regarding replacement paths to be displayed in the display unit 20 is included in the display area of the display unit 20 at the time when the display unit 20 displays the replacement paths, the path-replacement-processing unit 19 extracts the approximation path included in the display area of the display unit 20 as an approximation path that the display unit 20 needs to display.

In other words, in the display device 12a, the path-replacement-processing unit 19 extracts, on the basis of path approximation information generated by the path-approximation-information generation unit 17, an approximation path that the display unit 20 needs to display, and performs the path replacement processing on the tool movement paths before being replaced with the extracted approximation path. As a result, the path replacement processing is performed after reducing the number of tool movement paths subject to the path replacement processing, which leads to reduction of the time required for display.

### Embodiment 2

A numerical control system provided with a display device according to Embodiment 2 is explained. In Embodiment 2, the display device to display replacement paths replaced by a path-replacement-processing unit superposed with a three-dimensional shape model of a workpiece to be machined by a tool is explained. Note that, means, components, or the like that are the same as or similar to those in Embodiment 1 are denoted by the same names and symbols, and explanations thereof will be omitted.

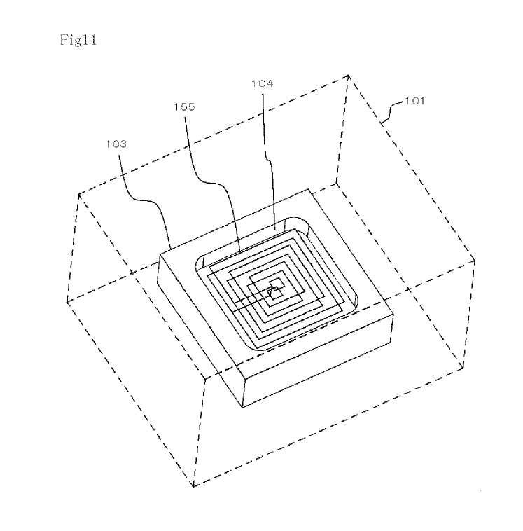

FIG. 9 is a block diagram showing a configuration of a numerical control system according to Embodiment 2. In a numerical control system 1b shown in FIG. 9, a display device 12b includes, different from Embodiment 1, a three-dimensional-shape-model storage 23. The three-dimensional-shape-model storage 23 receives a three-dimensional shape model from the outside of the numerical control system 1b, and stores the three-dimensional shape model.

A configuration display unit 21, as in Embodiment 1, acquires replacement paths after replacing tool movement paths from a path-replacement-processing unit 19, and acquires the stored three-dimensional shape model from the three-dimensional-shape-model storage 23. The configuration display unit 21 arranges, in the display area 102 in a three-dimensional space 101, the acquired replacement paths superposed with the three-dimensional shape model, and displays them on the display screen.

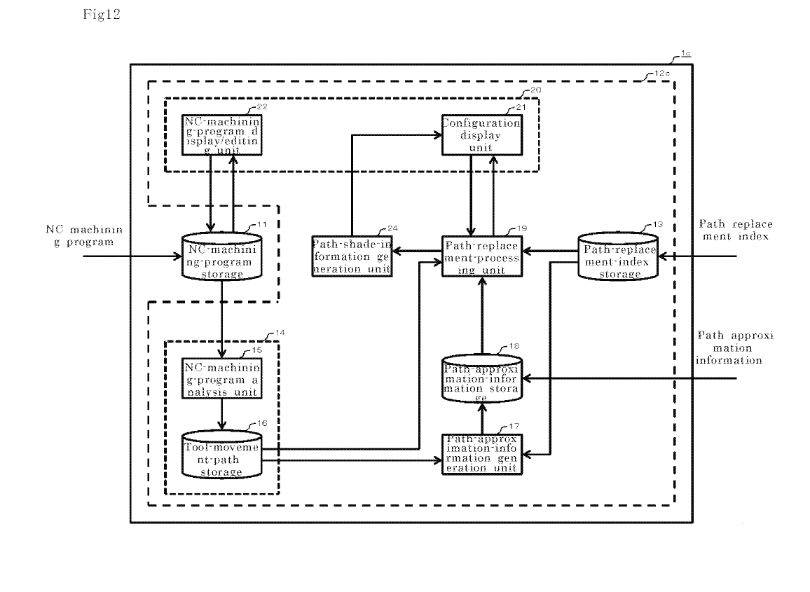

FIG. 10 is a flowchart showing a procedure for editing an NC machining program with replacement paths displayed in the display device of the numerical control system according to Embodiment 2. Referring to FIG. 10, a method of displaying the replacement paths and the three-dimensional shape model, and editing the NC machining program by the display device 12b of the numerical control system 1b according to Embodiment 2 is explained.

Note that, because Embodiment 2 is different from Embodiment 1 in operations in Step S21 and Step S25 in FIG. 10, explanations of Step S21 and Step S25 in FIG. 10 are made here, and explanations of the rest of the steps are omitted.

In Step S21 in FIG. 10, a NC-machining-program storage 11 stores an NC machining program inputted from the outside of the numerical control system 1b, and a path-replacement-index storage 13 stores a path-replacement-index inputted from the outside of the numerical control system 1b. The three-dimensional-shape-model storage 23 stores a three-dimensional shape model inputted from the outside of the numerical control system 1b.

The three-dimensional shape model stored in the three-dimensional-shape-model storage 23 is, for example, a three-dimensional shape model modeled after a workpiece shape, which is used to generate the NC machining program stored in the NC-machining-program storage 11 with external CAM software or the like. Alternatively, the three-dimensional shape model may be, for example, a three-dimensional shape model expressing a shape obtained by machining simulation performed using the NC machining program stored in the NC-machining-program storage 11.

In Step S25 in FIG. 10, the configuration display unit 21 acquires, from the path-replacement-processing unit 19, replacement paths having been replaced by path replacement processing in Step S14 in FIG. 10, and arranges and displays the acquired replacement paths in the three-dimensional space 101. Then, the configuration display unit 21 acquires the three-dimensional shape model from the three-dimensional-shape-model storage 23, makes the coordinate system of the acquired three-dimensional shape model coincide with the coordinate system of the replacement paths, and arranges and displays the acquired three-dimensional shape model superposed with the replacement paths in the display area 102 in the three-dimensional space 101.

FIG. 11 is a perspective view showing a three-dimensional space displayed in the configuration display unit according to Embodiment 2. In FIG. 11, a three-dimensional shape model 103 is a three-dimensional shape model that the configuration display unit 21 acquires from the three-dimensional-shape-model storage 23. Replacement paths 155 are replacement paths after the path-replacement-processing unit 19 has performed the path replacement processing on tool movement paths for machining a pocket area 104 of the three-dimensional shape model 103. As shown in FIG. 11, the configuration display unit 21 arranges the three-dimensional shape model 103 superposed with the replacement paths 155 in the three-dimensional space 101. At this time, the configuration display unit 21 can display, by having the coordinate system of the three-dimensional shape model 103 coincide with that of the replacement paths 155, the pocket area 104 of the three-dimensional shape model 103 arranged in superposition with the replacement paths 155.

As explained in the above, the display unit 20 according to Embodiment 2 displays the replacement paths replaced by the path-replacement-processing unit 19 superposed with the three-dimensional shape model 103 of a workpiece to be machined by a tool. As a result, the configuration display unit 21 can display the replacement paths that resulted from path replacement processing superposed with the three-dimensional shape model 103 modeled after the shape of a workpiece expected to be machined through the tool movement path. Thus, an operator can check the replacement paths in association with the three-dimensional model 103, and this leads to an effect that operations of checking and editing data of the NC machining program are made easier.

### Embodiment 3

A numerical control system provided with a display device according to Embodiment 3 is explained. In Embodiment 3, a display device to display a replacement path replaced by a path-replacement-processing unit with a shade of color corresponding to an angle between the replacement path and a reference vector is explained. Note that, means, components, or the like that are the same as or similar to those in Embodiment 1 are denoted by the same names and symbols, and explanations thereof will be omitted.

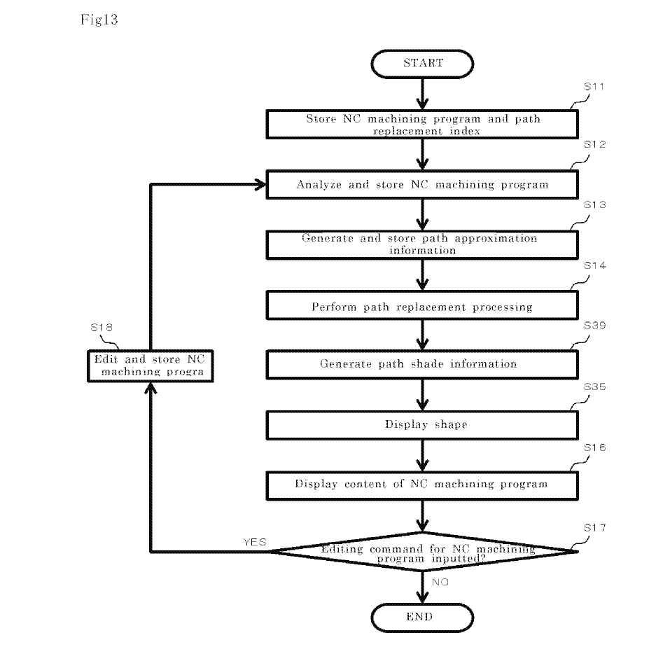

FIG. 12 is a block diagram showing a configuration of a numerical control system according to Embodiment 3. In a numerical control system 1c shown in FIG. 12, a display device 12c includes, different from Embodiment 1, a path-shade-information generation unit 24. The path-shade-information generation unit 24 acquires, from a path-replacement-processing unit 19, replacement paths having been replaced by path replacement processing similar to that in Embodiment 1, and generates path shade information on the basis of the acquired replacement paths. The path-shade-information generation unit 24, when setting a color to each replacement path by designating a number, gives each replacement path a value of the path shade information as a ratio of brightness.

A configuration display unit 21 acquires, as in Embodiment 1, from a path-replacement-processing unit 19, replacement paths having replaced tool movement paths, and acquires path shade information from the path-shade-information generation unit 24. The configuration display unit 21 gives, on the basis of the acquired replacement paths and the path shade information, the replacement paths a color with brightness based on the value of the path shade information. The configuration display unit 21 arranges the colored replacement paths in the display area 102 in the three-dimensional space 101, and displays them on the display screen.

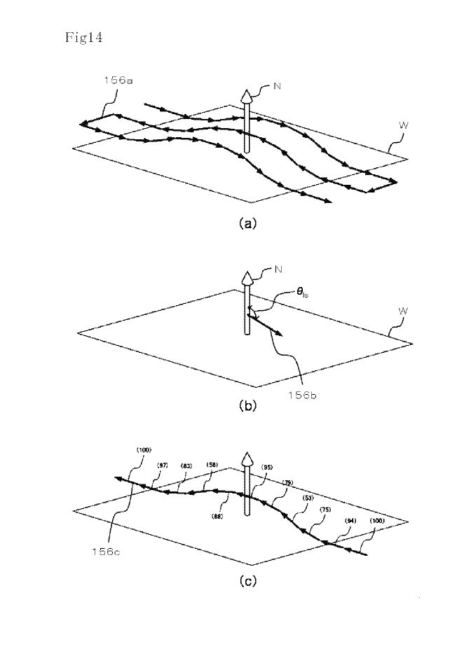

FIG. 13 is a flowchart showing a procedure for editing an NC machining program with replacement paths displayed in the display device of the numerical control system according to Embodiment 3. Referring to FIG. 13, a method of displaying the replacement paths and editing the NC machining program by the display device 12c of the numerical control system 1c according to Embodiment 3 is explained.

Note that, because Embodiment 3 is different from Embodiment 1 in operations in Step S35 and Step S39 shown in FIG. 13, explanations of Step S35 and Step S39 in FIG. 13 are made here, and explanations of the rest of the steps are omitted.

In Step S39 in FIG. 13, the path-shade-information generation unit 24 acquires, from the path-replacement-processing unit 19, replacement paths having been replaced by the path replacement processing in S14, and generates path shade information on the basis of the acquired replacement paths.

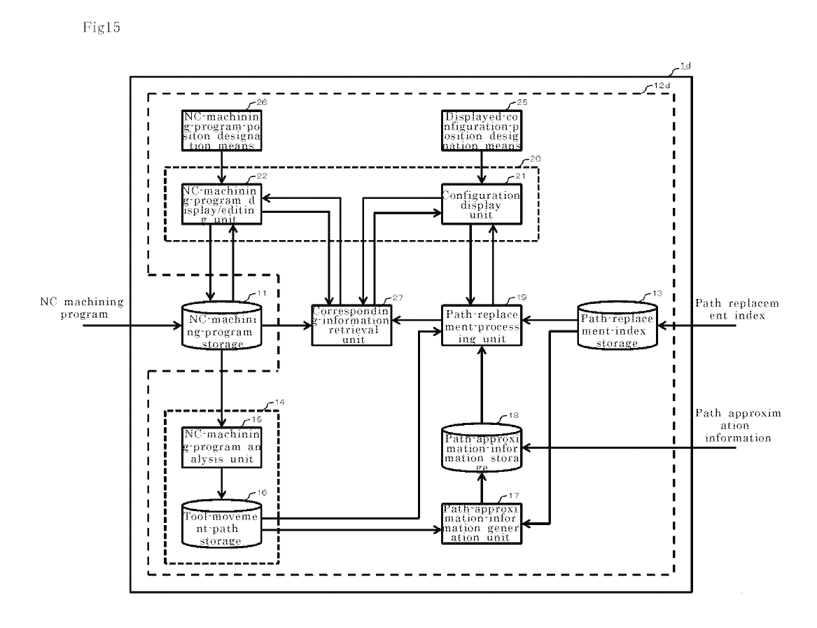

FIG. 14 is a conceptual diagram showing a method of generating path shade information according to Embodiment 3. Referring to FIG. 14, a method of generating path shade information by the path-shade-information generation unit 24 according to Embodiment 3 is explained.

In FIG. 14(a), a replacement path 156a is a replacement path acquired from the path-replacement-processing unit 19 by the path-shade-information generation unit 24. A plain W is a reference plain in the three-dimensional space where the replacement paths are arranged. A normal vector N is a normal vector perpendicular to the plain W.

Note that, the plain W may be, for example, an XY plain, a YZ plain, or a ZX plain of the coordinate system in which the replacement paths are arranged, or may be, in the three-dimensional space in which the replacement paths are arranged, a plain whose normal vector N coincides with a vector representing a present display direction.

In FIG. 14(b), the path-shade-information generation unit 24 calculates an angle θₗₛ with respect to a replacement path 156b. The angle θₗₛ is an angle between a moving direction vector of the replacement path 156b and the normal vector N. In this case, if the angle is larger than 90 degrees, the angle θₗₛ is calculated as an exterior angle of the angle. For example, if the angle is 110 degrees, the angle θₗₛ is calculated as 70 degrees.

The path-shade-information generation unit 24 calculates, with respect to each replacement path shown in FIG. 14(a), similarly to the replacement path 156b, an angle between a moving direction vector of the replacement path and the normal vector N. Note that, in the following, the angle θₗₛ refers to an angle between the normal vector N and a moving direction vector of a replacement path, which is not limited to the replacement path 156b.

The path-shade-information generation unit 24 calculates path shade information for each replacement path by interpolation in accordance with the calculated angle θₗₛ.

As a method of calculating the path shade information by interpolation in accordance with the angle θₗₛ, there is, for example, a method in which a range of color component values to be changed is stored in advance, accompanying the NC machining program, in the NC-machining-program storage 11, and the path-shade-information generation unit 24 calculates, in accordance with the calculated angle θₗₛ, the path shade information by interpolating color component values within the range of the color component values stored in the NC-machining-program storage 11.

Values of path shade information in FIG. 14(c) are values of path shade information calculated with respect to some of the replacement paths shown in FIG. 14(a). The path-shade-information generation unit 24 calculates, in accordance with a value of the angle θₗₛ calculated with respect to each replacement path, a value of the path shade information as an integer in a range from 0 to 100. In this case, the path-shade-information generation unit 24 linearly interpolates the value of the path shade information to be closer to 100 when the angle θₗₛ is closer to 90 degrees and closer to 0 when the angle θₗₛ is closer to 0 degree. In other words, the closer to 90 degrees the angle between the moving direction vector of the replacement path and the normal vector N is, the larger the value of the replacement path is.

The above is the explanation of the method of generating the path shade information by the path-shade-information generation unit 24 according to Embodiment 3. The path-shade-information generation unit 24, when setting a color to each replacement path by designating a number, gives each replacement path a value of the path shade information as a ratio of brightness. For example, the brightness is set to 0 when the value of the path shade information is 0, the brightness is set to the maximum when the value of the path shade information is 100, and the brightness corresponding to the value of the path shade information is linearly interpolated and given to each replacement path.

In Step S35 in FIG. 13, the configuration display unit 21 acquires, from the path-replacement-processing unit 19, the replacement paths having been replaced by the path replacement processing in Step S14, acquires the path shade information from the path-shade-information generation unit 24, gives, on the basis of the acquired replacement paths and the acquired path shade information, the replacement paths colors with brightness corresponding to the value of the path shade information, and arranges and displays the replacement paths with the colors in the three-dimensional space 101.

Thus, the configuration display unit 21 displays the replacement paths attached with the colors with brightness corresponding to the value of the given path shade information. As a result, the configuration display unit 21 can display each replacement path with a shade of color corresponding to the angle θₗₛ.

As explained in the above, the display unit 20 according to Embodiment 3 displays a replacement path replaced by the path-replacement-processing unit 19 with a shade of color corresponding to an angle between the replacement path and a predetermined reference vector. As a result, even when separation of replacement paths displayed on the display screen of the configuration display unit 21 is unclear, colors with shades attached to the replacement paths facilitate grasp of positional relationships between consecutive replacement paths, and this leads to an effect that operations of checking and editing data of the NC machining program by an operator are made easier.

### Embodiment 4

A numerical control system provided with a display device according to Embodiment 4 is explained. In Embodiment 4, a display device that retrieves a movement command corresponding to a replacement path extracted from replacement paths displayed in a display unit to display data of an NC machining program by highlighting the retrieved movement command, or a display device that retrieves a replacement path corresponding to a movement command extracted from data of an NC machining program displayed in a display unit to display the replacement paths replaced by a path-replacement-processing unit by highlighting the retrieved replacement path is explained. Note that, means, components, or the like that are the same as or similar to those in Embodiment 1 are denoted by the same names and symbols, and explanations thereof will be omitted.

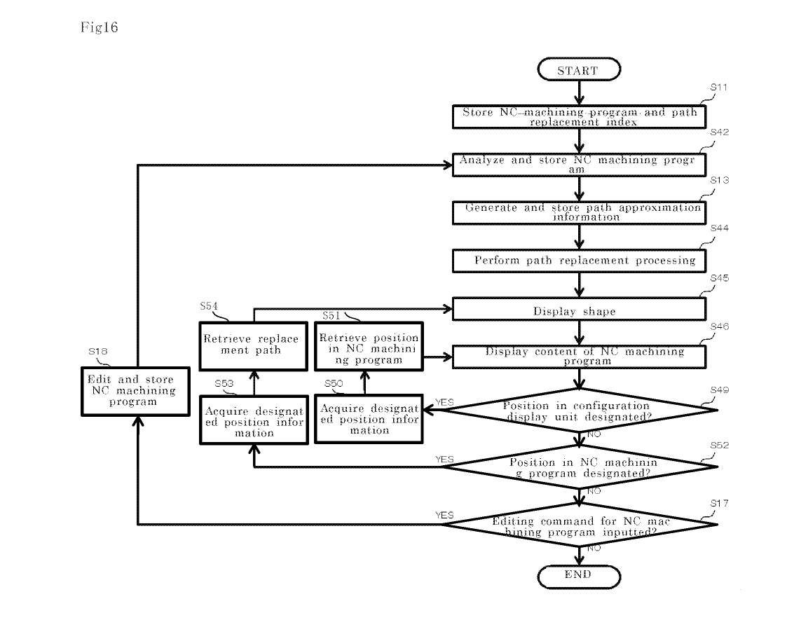

FIG. 15 is a block diagram showing a configuration of a numerical control system according to Embodiment 4. In Embodiment 4, an NC-machining-program analysis unit 15 calculates, on the basis of a calculated tool movement path, position information which is a position in the NC machining program corresponding to the calculated tool movement path. A tool-movement-path storage 16 receives the tool movement path from the NC-machining-program analysis unit 15, and stores the received tool movement path accompanied by the calculated position information.

In a numerical control system 1d according to Embodiment 4, a display device 12d includes, different from Embodiment 1, a displayed-configuration-position designation means 25, an NC-machining-program-position designation means 26, and a corresponding-information retrieval unit 27.

The displayed-configuration-position designation means 25 designates a position on a display screen of a configuration display unit 21. The NC-machining-program-position designation means 26 designates a position on a display screen of a NC-machining-program display/editing unit 22.

The corresponding-information retrieval unit 27 acquires, from the configuration display unit 21, information on a designated position designated by the displayed-configuration-position designation means 25. The corresponding-information retrieval unit 27 acquires, from the NC-machining-program display/editing unit 22, information on a designated position designated by the NC-machining-program-position designation means 26.

The corresponding-information retrieval unit 27 acquires, from the path-replacement-processing unit 19, replacement paths having been replaced by path replacement processing, and acquires an NC machining program from an NC-machining-program storage 11.

The corresponding-information retrieval unit 27, on the basis of the information on the designated position and replacement paths acquired from the configuration display unit 21, extracts an arbitrary replacement path from replacement paths displayed in the configuration display unit 21, and, on the basis of the extracted replacement path and the acquired NC machining program, searches data of machining program for a tool movement command corresponding to the extracted replacement path.

The corresponding-information retrieval unit 27, on the basis of the information on the designated position and the data of the NC machining program acquired from the NC-machining-program display/editing unit 22, extracts an arbitrary tool movement command from data of the NC machining program displayed in the NC-machining-program display/editing unit 22. The corresponding-information retrieval unit 27, on the basis of the extracted tool movement command and the acquired replacement paths, searches the replacement paths replaced by the path-replacement-processing unit 19 for a replacement path corresponding to the extracted tool movement command.

The configuration display unit 21 acquires replacement paths from the path-replacement-processing unit 19, acquires the retrieved replacement path from the corresponding-information retrieval unit 27, and when displaying replacement paths having been replaced by the path replacement processing, highlights the retrieved replacement path.

The NC-machining-program display/editing unit 22 acquires the NC machining program from the NC-machining-program storage 11, acquires the retrieved tool movement command from the corresponding-information retrieval unit 27, and highlights the acquired tool movement command when displaying the acquired data of the NC machining program.

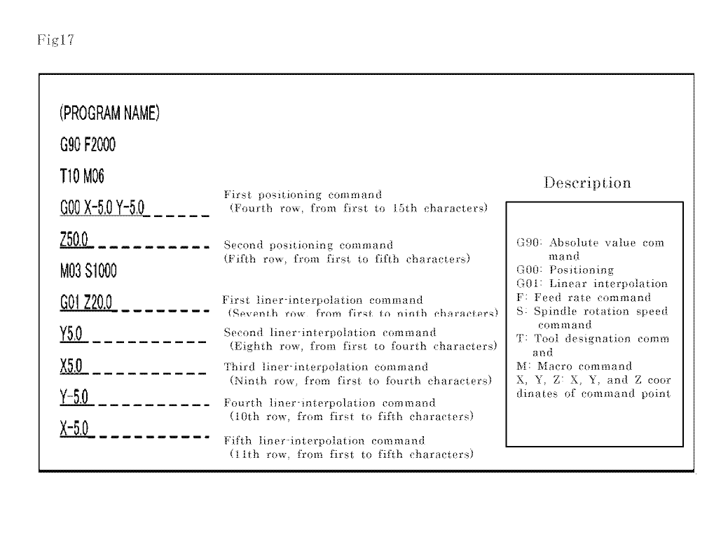

FIG. 16 is a flowchart showing a procedure for editing an NC machining program with replacement paths displayed in the display device of the numerical control system according to Embodiment 4. Referring to FIG. 16, a method of displaying replacement paths and editing an NC machining program by the display device 12d according to Embodiment 4 is explained.

Note that, in Embodiment 4, processing shown in FIG. 16 is the same as the processing shown in FIG. 2 according to Embodiment 1 in operations in Steps S11, S13, S17, and S18, and is different in operations in Steps S42, S44, S45, S46, S49, S50, S51, S52, S53, and S54. Thus, Steps S42, S44, S45, S46, S49, S50, S51, S52, S53, and S54 that are different from Embodiment 1 are explained here, and explanations of the rest of the steps are omitted.

In Step S42 in FIG. 16, the NC-machining-program analysis unit 15 analyzes an NC machining program acquired from the NC-machining-program storage 11, and calculates, in accordance with movement commands written in the NC machining program for a tool in a three-dimensional coordinate system, tool movement paths in the three-dimensional coordinate system. The NC-machining-program analysis unit 15 further calculates position information which is a position in the NC machining program corresponding to the calculated tool movement path.

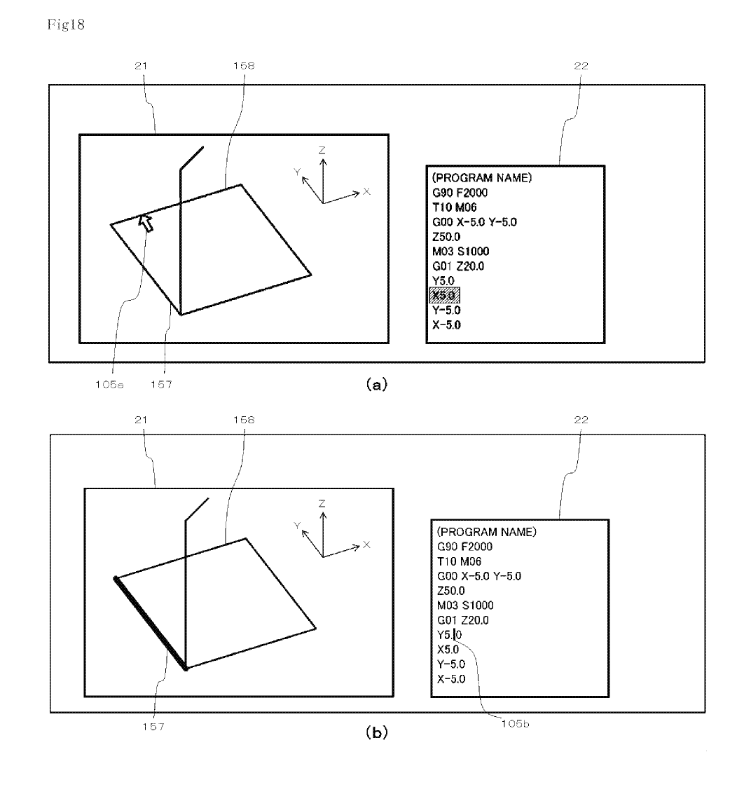

FIG. 17 is a conceptual diagram showing a method of calculating position information of an NC machining program. Referring to FIG. 17, a method of calculating position information on a command in the NC machining program by the NC-machining-program analysis unit 15 is explained.

In FIG. 17, letters or numbers written in the left-most column are data of the NC machining program. Explanations described in the right end are explanations of commands or the like such as so-called G-codes, which are used in NC machining programs.

In FIG. 17, the NC-machining-program analysis unit 15, with respect to commands for a starting point and an end point of each tool movement path, uniquely converts the position and the range in an NC machining program on which these commands are written into position information using the row number, the character number, the byte number, or the like. For example, with respect to a command of “G00 X-5.0 Y-5.0” in the data of the NC machining program shown in FIG. 17, that is, the first positioning command, the NC-machining-program analysis unit 15 converts the position and the range of the command in the NC machining program into position information of “the fourth row, from the first to the 15th characters”. For another example, the NC-machining-program analysis unit 15, with respect to a command of “X5.0” in the data of the NC machining program shown in FIG. 17, that is, the third liner-interpolation command, converts a position and a range of which in the NC machining program into position information of “the ninth row, from the first to the fourth characters”. In this way, the NC-machining-program analysis unit 15 calculates position information by converting a position of a command in the NC machining program into the row number and the character number.

Note that, a tool movement command denotes, in Embodiment 4, the first positioning command, the third linear-interpolation command, or the like shown in FIG. 17.

In this way, the NC-machining-program analysis unit 15 calculates, with respect to movement commands written in the NC machining program for a tool in the three-dimensional coordinate, position information in the NC machining program corresponding to a calculated tool movement path.

In Step S42 in FIG. 16, the tool-movement-path storage 16 receives a tool movement path from the NC-machining-program analysis unit 15, and stores the received tool movement path accompanied by the calculated position information.

In Step S44, path-replacement-processing unit 19, as in Embodiment 1, replaces tool movement paths with a replacement path by the path replacement processing. At this time, position information accompanying the tool movement paths is taken over by the replacement path after being replaced. In other words, by the path-replacement-processing unit 19, with respect to consecutive tool movement paths before being replaced with a replacement path, position information of a command related to the start point of the first tool movement path and position information of a command related to the end point of the last tool movement path are taken over as position information of the start point and the end point of the replacement path after being replaced.

In Step S45, the configuration display unit 21 acquires, as in Embodiment 1, replacement paths having been replaced by the path replacement processing from the path-replacement-processing unit 19, arranges the acquired replacement paths in a three-dimensional space 101, and displays them on the display screen.

In Step S46, the NC-machining-program display/editing unit 22 displays, as in Embodiment 1, data of an NC machining program acquired from the NC-machining-program storage 11 on the display screen, and allows input of an editing command for the NC machining program.

In Step S49, the configuration display unit 21 monitors whether a command to designate a position on the display screen is inputted by the displayed-configuration-position designation means 25. If a command to designate a position is inputted by the displayed-configuration-position designation means 25 (YES in Step S49), the configuration display unit 21 acquires, in Step S50, information on the designated position designated by the displayed-configuration-position designation means 25; then, the processing proceeds to Step S51 in FIG. 16.

The displayed-configuration-position designation means 25 is, for example, a pointing device such as cursor-movement keys on a keyboard, a mouse, and a touch panel. An operator operates the displayed-configuration-position designation means 25 as a pointing device to move a cursor or the like displayed on the display screen of the configuration display unit 21. The operator places the cursor or the like on a shape he or she wishes to select from shapes displayed on the display screen of the configuration display unit 21, and inputs a command to designate its position. When a command to designate a position on the display screen is inputted, the displayed-configuration-position designation means 25 selects the position on which the cursor or the like is displayed as the designated position. In this way, the displayed-configuration-position designation means 25 can designate a position on the display screen of the configuration display unit 21.

In Step S51 in FIG. 16, the corresponding-information retrieval unit 27 acquires, from the configuration display unit 21, information on the designated position designated by the displayed-configuration-position designation means 25, acquires replacement paths from the path-replacement-processing unit 19, and acquires the NC machining program from the NC-machining-program storage 11. The corresponding-information retrieval unit 27 extracts, on the basis of the information on the designated position and the replacement paths, a replacement path corresponding to the designated position from the replacement paths displayed in the configuration display unit 21. The corresponding-information retrieval unit 27 searches, on the basis of the extracted replacement path and the acquired NC machining program, data of the NC machining program for a tool movement command corresponding to the extracted replacement path.

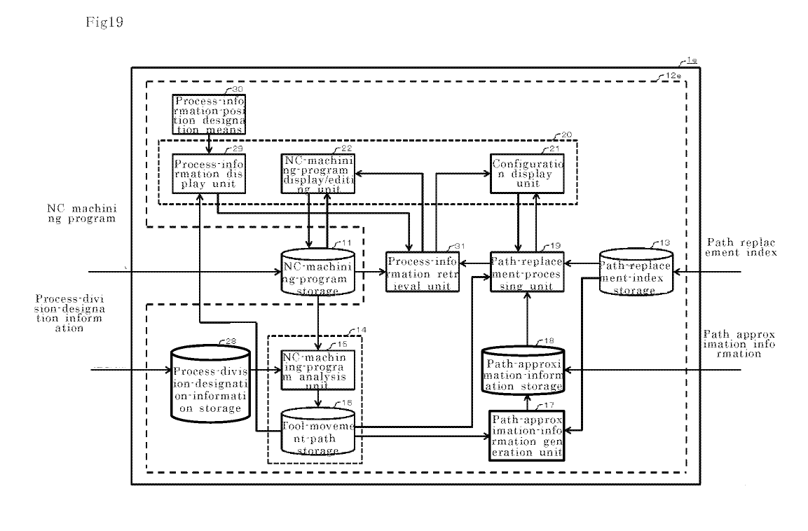

FIG. 18 is a diagram showing display screens of a display unit according to Embodiment 4. Referring to FIG. 18, a method of extracting a replacement path corresponding to the designated position, and searching for a tool movement command corresponding to the extracted replacement path, by the corresponding-information retrieval unit 27. Note that, in FIG. 18, the NC-machining-program display/editing unit 22 displays the data of the NC machining program shown in FIG. 17.

Note that, in FIG. 18, the start point of a replacement path 157 displayed in the configuration display unit 21 is a position corresponding to a command “G01 Z20.0” in the seventh row in data of the NC machining program shown in the NC-machining-program display/editing unit 22. The end point of the replacement path 157 is a position corresponding to a command “Y5.0” in the eighth row in the data of the NC machining program shown in the NC-machining-program display/editing unit 22. The start point of a replacement path 158 displayed in the configuration display unit 21 is a position corresponding to the command “Y5.0” in the eighth row in the data of the NC machining program shown in the NC-machining-program display/editing unit 22. The end point of the replacement path 158 is a position corresponding to a command “X5.0” in the ninth row in the data of the NC machining program shown in the NC-machining-program display/editing unit 22.

A method of extracting a replacement path corresponding to a designated position by the corresponding-information retrieval unit 27 is explained. In FIG. 18(a), the corresponding-information retrieval unit 27 arranges, for example, a line virtually extending from the point of an arrow that a cursor 105a points at in a direction of the arrow in the three-dimensional space 101 in the configuration display unit 21, determines interference between the line and each replacement path, and extracts the replacement path 158 interfering with the line.

Note that, a method of extracting a replacement path corresponding to a designated position by the corresponding-information retrieval unit 27 is explained as follows. The corresponding-information retrieval unit 27, in the three-dimensional space 101 in the configuration display unit 21 where replacement paths are arranged, virtually arranges a line, whose directional vector is a depth direction of configuration display unit 21 when a position is designated by the displayed-configuration-position designation means 25, and whose start point is the designated position. Interference between the line and each replacement path arranged in the three-dimensional space 101 is determined, and if there is a replacement path under interference, this replacement path is extracted. In this way, the corresponding-information retrieval unit 27 can extract a replacement path corresponding to a designated position.

A method of retrieving a tool movement command corresponding to a replacement path extracted by the corresponding-information retrieval unit 27 is explained. In FIG. 18(a), the corresponding-information retrieval unit 27, with respect to the extracted replacement path 158, on the basis of position information accompanying the replacement path 158, retrieves a command at a position indicated by the position information in the NC machining program.

The corresponding-information retrieval unit 27 uses, for example, of the position information accompanying the extracted replacement path, position information corresponding to the end point of the replacement path. The replacement path 158 shown in FIG. 18 is accompanied by position information “the ninth row, from the first to the fourth character” as shown in FIG. 17 as the position information corresponding to the end point. In the position of “the ninth row, from the first to the fourth character” in the NC machining program, as described above, there is a command “X5.0” in the data of the NC machining program. Thus, the corresponding-information retrieval unit 27 retrieves, as a tool movement command corresponding to the extracted replacement path 158, the command “X5.0” in the data of the NC machining program. In this way, the corresponding-information retrieval unit 27 can retrieve a tool movement command corresponding to an extracted replacement path.

Note that, the corresponding-information retrieval unit 27 may use, of information accompanied by an extracted replacement path, position information corresponding to the start point of the replacement path. Alternatively, the corresponding-information retrieval unit 27 may use, of position information accompanying an extracted replacement path, a range of a series of position information from the start point to the end point of the replacement path.

Thus, as shown in FIG. 17, if position information accompanying the start point of the replacement path 158 is “the eighth row, from the first to the fourth character” and the position information accompanying the end point of the replacement path 158 is “the ninth row, from the first to the fourth character”, the corresponding-information retrieval unit 27 may use either of the above as the position information, or may use “from the first character in the eighth row to the fourth character in the ninth row” as the position information.

In Step S46 in FIG. 16, the NC-machining-program display/editing unit 22 acquires an NC machining program from the NC-machining-program storage 11, acquires a tool movement command retrieved from the corresponding-information retrieval unit 27, and when displaying acquired data of the NC machining program, highlights the acquired tool movement command. The NC-machining-program display/editing unit 22, in a display screen, highlights an area in which the acquired tool movement command is displayed, for example, by changing the background color, character color, character format, or the like.

In FIG. 18(a), the NC-machining-program display/editing unit 22, with respect to the replacement path 158 that is designated and extracted by the cursor 105a displayed in the configuration display unit 21, highlights a command “X5.0”, which is a tool movement command corresponding to the replacement path 158.

In Step S49 in FIG. 16, if a command to designate a position is not inputted by the displayed-configuration-position designation means 25 (No in Step S49), the processing proceeds to Step S52 in FIG. 16.

In Step S52, the NC-machining-program display/editing unit 22 monitors whether a command to designate a position on the display screen is inputted by the NC-machining-program-position designation means 26. If a command to designate a position is inputted by the NC-machining-program-position designation means 26 (YES in Step S52), the NC-machining-program display/editing unit 22 acquires, in Step S53, information on the designated position designated by the NC-machining-program-position designation means 26; then, the processing proceeds to Step S54 in FIG. 16.

The NC-machining-program-position designation means 26, configured similarly to the displayed-configuration-position designation means 25, is, for example, a pointing device such as cursor-movement keys on a keyboard, a mouse, and a touch panel. Note that, the displayed-configuration-position designation means 25 and the NC-machining-program-position designation means 26 are not limited to be provided as individual means, but may be provided as one means having both functions.

In Step S54 in FIG. 16, the corresponding-information retrieval unit 27 acquires, from the NC-machining-program display/editing unit 22, information on a designated position designated by the NC-machining-program-position designation means 26, acquires the NC machining program from the NC-machining-program storage 11, and acquires replacement paths from the path-replacement-processing unit 19. The corresponding-information retrieval unit 27 extracts, on the basis of the information on the designated position and data of the NC machining program, a tool movement command corresponding to the designated position from data of the NC machining program displayed in the NC-machining-program display/editing unit 22. The corresponding-information retrieval unit 27 calculates, with respect to the extracted tool movement command, position information of the NC machining program, and searches, on the basis of the calculated position information and the acquired replacement paths, the replacement paths replaced by the path-replacement-processing unit 19 for a replacement path corresponding to the calculated position information.

The corresponding-information retrieval unit 27, when the NC-machining-program-position designation means 26 designates a position on a display screen of the NC-machining-program display/editing unit 22, extracts a command written in the designated position from the data of the NC machining program displayed in the NC-machining-program display/editing unit 22 as a tool movement command corresponding to the designated position. For example, when the cursor 105b is moved on a position shown in FIG. 18(b) and the position is designated, the corresponding-information retrieval unit 27 extracts a command “Y5.0” as a tool movement command corresponding to the designated position.

A method of calculating position information of the NC machining program with respect to the extracted tool movement command is similar to the method shown in the above-mentioned Step S42. Thus, the corresponding-information retrieval unit 27, with respect to the extracted tool movement command, uniquely converts a position and a range in the NC machining program on which the command is written into position information using the number of the row, the number of the character, the number of the byte, or the like. In FIG. 18(b), the corresponding-information retrieval unit 27, for example, with respect to a command “Y5.0”, calculates position information in the NC machining program as “the eighth row, from the first to the fourth character”.

As a method of retrieving a replacement path corresponding to the calculated position information, there is a method of comparing the calculated position information with position information accompanying the acquired replacement paths. Note that, the acquired replacement paths are those after the path replacement processing is performed by the path-replacement-processing unit 19. Thus, there is a case where a replacement path whose start point or end point is accompanied by uniquely equivalent information cannot be retrieved as a replacement path corresponding to the calculated position information. In this case, if the calculated position information is positioned between position information accompanying the start point and position information accompanying the end point of a certain replacement path, this replacement path is determined to be a retrieved replacement path. If a replacement path corresponding to the calculated position information is determined to be not required for display in the path-replacement-processing unit 19, no corresponding replacement path exists.

In Step S45 in FIG. 16, the configuration display unit 21 acquires replacement paths having been replaced by path replacement processing from the path-replacement-processing unit 19, acquires a retrieved replacement path from the corresponding-information retrieval unit 27, and highlights the retrieved replacement path when displaying replacement paths having been replaced by path replacement processing. Note that, the configuration display unit 21, for example, on the display screen, highlights a portion displaying the retrieved replacement path by changing line color, line style, or the like.

In FIG. 18(b), the configuration display unit 21, with respect to a command “Y5.0”, a tool movement command designated and extracted by the cursor 105b displayed in the NC-machining-program display/editing unit 22, highlights the replacement path 157, a replacement path corresponding to the command “Y5.0”.

In Step S52 in FIG. 16, if a command to designate a position is not inputted by the NC-machining-program-position designation means 26 (No in Step S52), the processing proceeds to Step S17 in FIG. 16.

As explained in the above, the display device 12d according to Embodiment 4 is provided with the corresponding-information retrieval unit 27 to search for data of an NC machining program for a movement command corresponding to a replacement path extracted from replacement paths displayed in a display unit 20, wherein the display unit 20 displays the data of the NC machining program by highlighting the movement command retrieved by the corresponding-information retrieval unit 27.

The display device 12d in the numerical control system 1d according to Embodiment 4 is provided with the corresponding-information retrieval unit 27 to search replacement paths replaced by the path-replacement-processing unit 19 for a replacement path corresponding to a movement command extracted from data of the NC machining program displayed in the display unit 20 displaying the data of the NC machining program, wherein the display unit 20 displays the replaced paths replaced by the path-replacement-processing unit by highlighting the replacement path retrieved by the corresponding-information retrieval unit 27.

As a result, efforts of retrieving the corresponding points between replacement paths displayed on the display screen of the configuration display unit 21 and data of the NC machining program displayed on the display screen of the NC-machining-program display/editing unit 22 can be omitted, and this leads to an effect that operations of checking and editing data of the NC machining program by an operator are made easier.

### Embodiment 5

A numerical control system provided with a display device according to Embodiment 5 is explained. In Embodiment 5, a display device that divides data of an NC machining program into arbitrary processes, calculates, in accordance with movement commands included in the arbitrarily divided processes, tool movement paths included in the arbitrarily divided processes, replaces, on the basis of the calculated tool movement paths and a predetermined index, consecutive tool movement paths included in the arbitrarily divided processes with a replacement path, and displays the replacement path is explained. Note that, means, components, or the like that are the same as or similar to those in Embodiment 1 are denoted by the same names and symbols, and explanations thereof will be omitted.

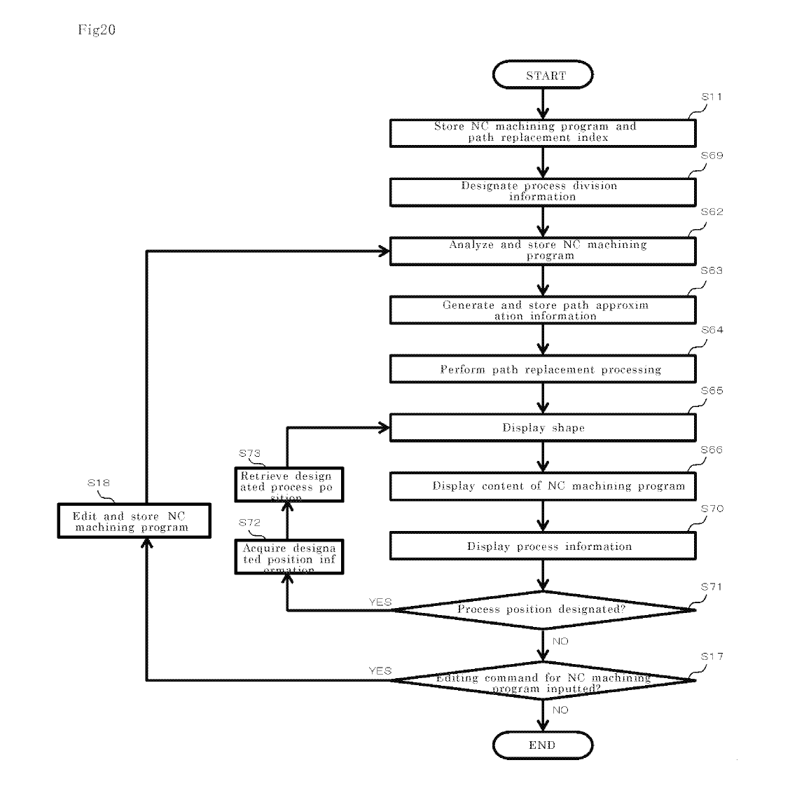

FIG. 19 is a block diagram showing a configuration of a numerical control system according to Embodiment 5. In the numerical control system 1e according to Embodiment 5, a display device 12e includes, different from Embodiment 1, a process-division-designation-information storage 28, a process-information display unit 29, a process-information-position designation means 30, and a process-information retrieval unit 31.

In Embodiment 5, the process-division-designation-information storage 28 stores process-division-designation information, which will be described later, inputted from the outside of the numerical control system 1e.

An NC-machining-program analysis unit 15 analyzes an NC machining program acquired from an NC-machining-program storage 11, acquires process-division-designation information from the process-division-designation-information storage 28, divides the NC machining program into arbitrary processes on the basis of the acquired NC machining program and the acquired process-division-designation information, and generates process information to be described later.

The NC-machining-program analysis unit 15 calculates, in accordance with tool movement commands included in arbitrarily divided processes, tool movement paths included in each process. At this time, the NC-machining-program analysis unit 15, as in Embodiment 1, in accordance with movement commands written in the NC machining program for a tool in a three-dimensional coordinate system, calculates tool movement paths in the three-dimensional coordinate system, and accompanies the process information with the calculated tool movement paths included in each process.

A tool-movement-path storage 16 stores process information inputted from the NC-machining-program analysis unit 15 accompanied by tool movement paths.

A path-approximation-information generation unit 17 acquires, from the tool-movement-path storage 16, process information and tool movement paths accompanying the process information, acquires a path-replacement-index from the path-replacement-index storage 13, and generates, on the basis of the process information and the path-replacement-index, path approximation information in such a way that an approximation path is not included in multiple processes.

A path-replacement-processing unit 19 acquires, from the tool-movement-path storage 16, process information and tool movement paths accompanying the process information, acquires path approximation information from a path-approximation-information storage 18, acquires a path-replacement-index from the path-replacement-index storage 13, and acquires, from a configuration display unit 21, a current display area and a current display magnification at the time when the configuration display unit 21 displays replacement paths. The path-replacement-processing unit 19, on the basis of the acquired process information, tool movement paths accompanying the process information, path-replacement-index, display area, and display magnification, performs path replacement processing to replace consecutive tool movement paths with a replacement path in such a way that the replacement path is not included in multiple processes. The path-replacement-processing unit 19 accompanies the process information with the calculated tool movement paths.

The configuration display unit 21 acquires, from the path-replacement-processing unit 19, process information and replacement paths accompanying the process information, and, on a display screen, disposes and displays the acquired replacement paths in a display area 102 in a three-dimensional space 101.

The process-information display unit 29 acquires the process information from the tool-movement-path storage 16, and displays the acquired process information. The process-information-position designation means 30 designate a position on a display screen of the process-information display unit 29.

The process-information retrieval unit 31 acquires, from the process-information display unit 29, information on the designated position designated by the process-information-position designation means 30, acquires the process information from the tool-movement-path storage 16, and extracts, on the basis of the acquired information on the designated position and process information, from the process information displayed in the process-information display unit 29, process information corresponding to the designated position.

The process-information retrieval unit 31 acquires process information and replacement paths accompanying the process information from the path-replacement-processing unit 19. The process-information retrieval unit 31, on the basis of the extracted process information and the acquired process information and replacement paths accompanying the process information, searches replacement paths replaced by the path-replacement-processing unit 19 for replacement paths corresponding to the process number of the extracted process information.

The process-information retrieval unit 31 acquires the stored NC machining program from the NC-machining-program storage 11. The process-information retrieval unit 31, on the basis of the extracted process information and acquired data of the NC machining program, searches the data of the NC machining program for a tool movement command corresponding to process position information of the extracted process information.

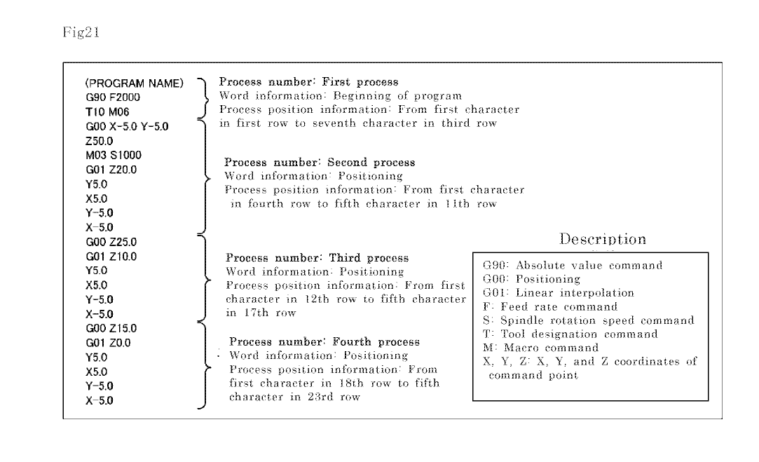

FIG. 20 is a flowchart showing a procedure for editing the NC machining program with replacement paths displayed in the display device of the numerical control system according to Embodiment 5. Referring to FIG. 20, a method of displaying replacement paths and editing the NC machining program by the display device 12e according to Embodiment 5 is explained.

Note that, in Embodiment 5, processing shown in FIG. 20 is the same as processing shown in FIG. 2 according to Embodiment 1 in operations in Steps S11, S17, and S18, and is different in operations in Steps S62, S63, S64, S65, S66, S69, S70, S71, S72, and S73. Thus, Steps S62, S63, S64, S65, S66, S69, S70, S71, S72, and S73, which are different portions from Embodiment 1, are explained here, but explanations of the rest of the steps are omitted.

In Step S69 in FIG. 20, the process-division-designation-information storage 28 stores process-division-designation information inputted from outside the numerical control system 1e. The process-division-designation information is information indicating how to divide the data when dividing data of the NC machining program stored in the NC-machining-program storage 11 into arbitrary processes. In the process-division-designation information, one of or a combination of specific words written in the NC machining program is designated. Specific words to be designated at this time may be chosen from a word group prepared in advance, or from any arbitrary words.

The words designated as ones in the word group prepared in advance are words indicating such meanings as Tool Selection, Coordinate System Selection, Call Subprogram, Program End, Call Non-Modal Macro, Set Position, Automatic Return to Origin, Sequence Number, Comment, Special Machining Mode On/Off, and Optional Block Skip. At the time of designation of process divisions, one of or a combination of words out of words indicating the above is designated.

In Step S62 in FIG. 20, the NC-machining-program analysis unit 15 acquires the NC machining program acquired from an NC-machining-program storage 11 to analyze it, acquires process-division-designation information from the process-division-designation-information storage 28, divides the NC machining program into arbitrary processes on the basis of the acquired NC machining program and tool-division-designation information, and generates process information. Here, the process information is information indicating each process obtained by the division.

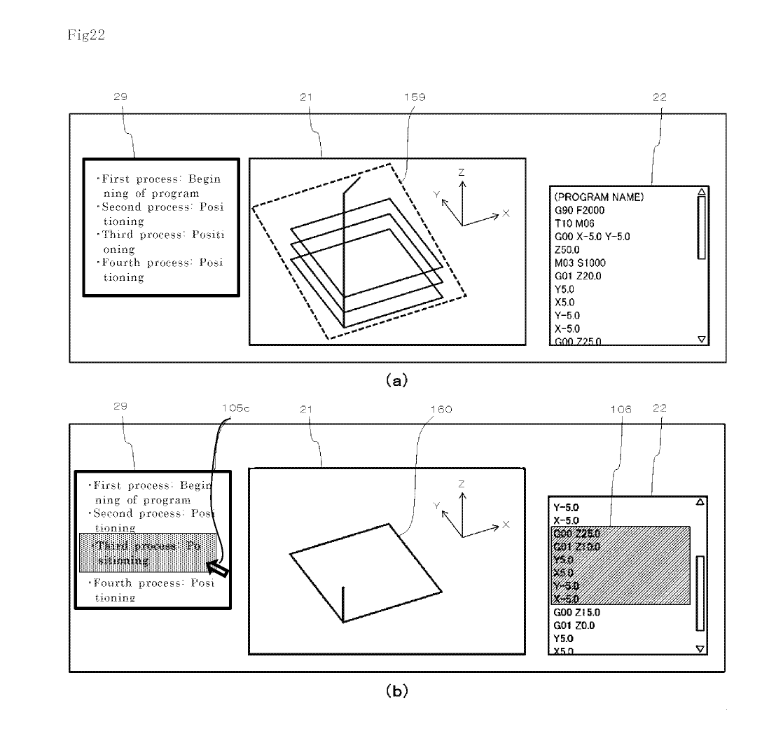

FIG. 21 is a conceptual diagram showing a method of dividing an NC machining program into arbitrary processes to generate process information. Referring to FIG. 21, a method of dividing the NC machining program into arbitrary processes to generate process information by the NC-machining-program analysis unit 15 is explained.

In FIG. 21, letters or numbers written in the left-most column are data of the NC machining program. Explanations described in the right end are explanations of commands or the like such as so-called G-codes, which are used in NC machining programs.

In FIG. 21, the NC-machining-program analysis unit 15 divides the NC machining program into arbitrary processes by setting “Set Position” as a word that process-division-designation information designates. The NC-machining-program analysis unit 15 divides, on the basis of the process-division-designation information, the NC machining program into four processes, namely, from the first process to the fourth process. The NC-machining-program analysis unit 15 generates process information for each process obtained by the division.

Here, the process information includes a process number, word information, and process position information. The process number is a number indicating what number the process is from the beginning of the NC machining program. The word information is information indicating by what word the process is divided. The process position information is information expressing the position and range of the process in the NC machining program by the row number, the character number, the byte number, or the like.

The NC-machining-program analysis unit 15 adds, for example, with respect to the third process in the divided result, information that the process number is “the third process”, the word information is “Set Position”, the process position information is “from the first character in the 12th row to the fifth character in the 17th row” to the process information of the process. Note that, when generating process information with respect to the first process in the divided result, the NC-machining-program analysis unit 15 generates process information that the word information is at the beginning of the program.

In Step S62 in FIG. 20, the NC-machining-program analysis unit 15 calculates, in accordance with tool movement commands included in arbitrarily divided processes, tool movement paths included in each process, and accompanies the process information with the tool movement paths included in each process.

In Step S62, the tool-movement-path storage 16 stores the process information inputted from the NC-machining-program analysis unit 15 accompanied by the tool movement paths.

In Step S63, a path-approximation-information generation unit 17 acquires, from the tool-movement-path storage 16, process information and tool movement paths accompanying the process information, acquires a path-replacement-index from the path-replacement-index storage 13, and generates, on the basis of the process information and the path-replacement-index, path approximation information in such a way that an approximation path is not included in multiple processes.

In Step S63, the path-approximation-information storage 18 stores the path approximation information inputted from the path-approximation-information generation unit 17.

In Step S64, a path-replacement-processing unit 19 acquires, from the tool-movement-path storage 16, process information and tool movement paths accompanying the process information, acquires path approximation information from a path-approximation-information storage 18, acquires a path-replacement-index from the path-replacement-index storage 13, and acquires, from a configuration display unit 21, the current display area and the current display magnification at the time when the configuration display unit 21 displays replacement paths. The path-replacement-processing unit 19, on the basis of the acquired process information, tool movement paths accompanying the process information, path-replacement-index, display area, and display magnification, performs the path replacement processing to replace consecutive tool movement paths with a replacement path in such a way that the replacement path is not included in multiple processes. The path-replacement-processing unit 19 accompanies the process information with the calculated tool movement paths.

Note that, a method of the path replacement processing performed by the path-replacement-processing unit 19 is similar to that explained in Embodiment 1.

In Step S65 in FIG. 20, the configuration display unit 21 acquires, from the path-replacement-processing unit 19, process information and replacement paths accompanying the process information, and disposes the acquired replacement paths in the three-dimensional space 101, and display them on a display screen.

FIG. 22 is a diagram showing display screens of the display unit according to Embodiment 5. The configuration display unit 21, as shown in FIG. 22(a), displays replacement paths 159 having been replaced by the path replacement processing.

In Step S66 in FIG. 20, the NC-machining-program display/editing unit displays data of an NC machining program acquired from the NC-machining-program storage 11 on a display screen, as shown in FIG. 22(a), and allows input of an editing command for the NC machining program. Note that, in FIG. 22, the NC-machining-program display/editing unit 22 displays the data of the NC machining program shown in FIG. 21.

In Step S70, the process-information display unit 29 acquires process information from the tool-movement-path storage 16, and displays the acquired process information as shown in FIG. 22(a).

Note that, when displaying the acquired process information, the process-information display unit 29 may display either or both of a process number and word information included in each piece of the process information.

In Step S71, the process-information display unit 29 monitors whether a command to designate a position on the display screen is inputted by the process-information-position designation means 30. If a command to designate a position is inputted by the process-information-position designation means 30 (YES in Step S71), the process-information display unit 29 acquires, in Step S72, information on the designated position designated by the process-information-position designation means 30; then, the processing proceeds to Step S73.

The process-information-position designation means 30, configured similarly to the displayed-configuration-position designation means 25 or the NC-machining-program-position designation means 26, is, for example, a pointing device such as cursor-movement keys on a keyboard, a mouse, and a touch panel. Note that, the displayed-configuration-position designation means 25, the NC-machining-program-position designation means 26, and the process-information-position designation means 30 are not limited to be provided as separate means, but may be provided as one means having all of those functions.

In Step S73, the process-information retrieval unit 31 acquires, from the process-information display unit 29, information on a designated position designated by the process-information-position designation means 30, acquires the process information from the tool-movement-path storage 16, and extracts, on the basis of the acquired information on the designated position and process information, a piece of process information corresponding to the designated position from the process information displayed in the process-information display unit 29.

The process-information retrieval unit 31, when the process-information-position designation means 30 designates a position on the display screen of the process-information display unit 29, extracts, from the process information displayed in the process-information display unit 29, a piece of process information displayed in the designated position as process information corresponding to the designated position. For example, when the cursor 105c is moved to a position shown in FIG. 22(b) and the position is designated, the process-information retrieval unit 31 extracts process information of the third process in the divided result made by the NC-machining-program analysis unit 15 as process information corresponding to the designated position.

In Step S73, the process-information retrieval unit 31 acquires, from the path-replacement-processing unit 19, process information and replacement paths accompanying the process information. The process-information retrieval unit 31, on the basis of the extracted piece of process information, and the acquired process information and replacement paths accompanying the process information, searches replacement paths replaced by the path-replacement-processing unit 19 for replacement paths corresponding to a process number of the extracted process information.

A method of retrieving replacement paths corresponding to the number of the extracted process information is performed as follows; from the process information acquired by the path-replacement-processing unit 19, process information corresponding to the number of the process information extracted by the process-information retrieval unit 31 is retrieved, and only the replacement paths accompanying the retrieved process information are extracted. For example, in the case shown in FIG. 22(b), because the number of the extracted process information is the third process, the process-information retrieval unit 31 extracts, from the replacement paths 159 accompanying the process information acquired from the path-replacement-processing unit 19, only replacement paths 160 accompanying the process information whose process number is the third process. In this way, the process-information retrieval unit 31 can retrieve replacement paths corresponding to the number of the extracted process information.

In Step S73, the process-information retrieval unit 31 acquires a stored NC machining program from the NC-machining-program storage 11. The process-information retrieval unit 31 searches, on the basis of the extracted process information and data of the NC machining program, the data of the NC machining program for tool movement commands corresponding to process position information of the extracted process information.

At this time, a method of retrieving tool movement commands corresponding to the process position information of the extracted process information is performed as follows; from the acquired data of the NC machining program, positions and ranges corresponding to information of the row number, the character number, the byte number, or the like included in the process position information of the extracted process information are extracted. For example, in the case shown in FIG. 22(b), the process position information of the extracted process information is “from the first character in the 12th row to the fifth character in the 17th row”. Positions and ranges of “from the first character in the 12th row to the fifth character in the 17th row” in the NC machining program correspond to commands from a command “G00 Z25.0” to a command “X-5.0” in the data of the NC machining program. Thus, the process-information retrieval unit 31 retrieves, as tool movement commands corresponding to the process position information of the extracted process information, tool movement commands in the positions and ranges from the command “G00 Z25.0” to the command “X-5.0”. In this way, the process-information retrieval unit 31 can retrieve tool movement commands corresponding to the process position information of the extracted process information.

In Step S65, the configuration display unit 21 acquires, from the process-information retrieval unit 31, retrieved replacement paths, and disposes the acquired replacement paths in the three-dimensional space 101, and displays them on a display screen. In FIG. 22(b), the configuration display unit 21 displays replacement paths 160 resulting from the path replacement processing performed on the tool movement paths accompanying the third process extracted by the process-information retrieval unit 31.

Note that, the configuration display unit 21 may further acquire, from the path-replacement-processing unit 19, the replacement paths having been replaced by the path replacement processing, and, when displaying the acquired replacement paths, may highlight the retrieved replacement paths 160. In this case, the configuration display unit 21 highlights, on the display screen, portions displaying the retrieved replacement paths 160, for example, by changing line color, line style, or the like.

In Step S66, the NC-machining-program display/editing unit 22 acquires the NC machining program from the NC-machining-program storage 11, and acquires the tool movement commands retrieved from the process-information retrieval unit 31. The NC-machining-program display/editing unit 22 highlights, when displaying the acquired data of the NC machining program, the acquired tool movement commands. The NC-machining-program display/editing unit 22 highlights, on a display screen, areas displaying the acquired tool movement commands, for example, by changing background color, character color, character format, or the like.

In FIG. 22(b), the NC-machining-program display/editing unit 22 highlights, with respect to the process position information of the third process “from the first character in the 12th row to the fifth character in the 17th row”, which is extracted by the process-information retrieval unit 31, the tool movement commands in positions and ranges corresponding to the process position information as a highlighted area 106 shows.

In Step S71 in FIG. 20, if a command to designate a position is not inputted by the process-information-position designation means 30 (No in Step S71), the processing proceeds to Step S17.

As explained in the above, in the display device 12e according to Embodiment 5, the tool-movement-path calculation means 14 divides data of the NC machining program into arbitrary processes, calculates, in accordance with movement commands included in the divided processes, tool movement paths included in the divided processes; and the path-replacement-processing unit 19 replaces, on the basis of the tool movement paths calculated by the tool-movement-path calculation means 14 and the predetermined index, consecutive tool movement paths included in the arbitrarily divided processes with a replacement path.

As a result, an operator can divide an NC machining program into arbitrarily designated processes. At the time of displaying replacement paths, only the replacement paths included in one of the divided processes can be highlighted, and also at the time of displaying data of the NC machining program, tool movement commands included in the one of the divided processes can be highlighted. Thus, it is possible to check data of an NC machining program by a unit of arbitrary processes, and this leads to an effect that operations of checking and editing data of the NC machining program are made easier.

### REFERENCE NUMERALS

1a, 1b, 1c, 1d, 1e: numerical control system,
11: NC-machining-program storage,
12a, 12b, 12c, 12d, 12e: display device,
13: path-replacement-index storage,
14: tool-movement-path calculation means,
15: NC-machining-program analysis unit, 16: tool-movement-path storage,
17: path-approximation-information generation unit,
18: path-approximation-information storage,
19: path-replacement-processing unit,
20: display unit, 21: configuration display unit,
22: NC-machining-program display/editing unit,
23: three-dimensional-shape-model storage,
24: path-shade-information generation unit,
25: displayed-configuration-position designation means,
26: NC-machining-program-position designation means,
27: corresponding-information retrieval unit,
28: process-division-designation-information storage,
29: process-information display unit,
30: process-information-position designation means,
31: process-information retrieval unit,
101: three-dimensional space, 102: display area,
103: three-dimensional shape model, 104: pocket area,
105a, 105b, 105c: cursor, 106: highlighted part,
111a, 111b, 111c, 111d, 111e, 111f, 112a, 112b, 112c, 112d, 112e, 112f: tool movement path,
113: tool movement path,
121, 122, 123, 124: virtual cylinder,
131, 132, 133: virtual cone,
141a, 141b, 142: approximation path,
151a, 151b, 152a, 152b, 152c, 152d, 153, 154, 155, 156a, 156b, 156c, 157, 158, 159, 160: replacement path.

1-23. (canceled)

24. A display device comprising:
a tool-movement-path calculator to calculate, on a basis of data of a machining program on which movement commands for a tool in a three-dimensional coordinate system are written, tool movement paths through which the tool moves in the three-dimensional coordinate system;
a path-replacement processor to replace, on a basis of the tool movement paths calculated by the tool-movement-path calculator and a predetermined index, consecutive tool movement paths with a replacement path; and
a display to display the replacement path,
wherein the display displays the replacement path to be visually distinguishable in accordance with an angle between the replacement path and a predetermined reference vector.

25. A display device comprising:
a tool-movement-path calculator to calculate, on a basis of data of a machining program on which movement commands for a tool in a three-dimensional coordinate system are written, tool movement paths through which the tool moves in the three-dimensional coordinate system;
a path-replacement processor to replace, on a basis of the tool movement paths calculated by the tool-movement-path calculator and a predetermined index, consecutive tool movement paths with a replacement path;
a display to display one or more replacement paths generated by performing the path replacement processing one or more times; and
a corresponding-information retrieval unit to retrieve, form the data of the machining program, a movement command corresponding to a replacement path extracted from the one or more replacement paths displayed in the display,
wherein the display displays by highlighting the movement command retrieved by the corresponding-information retrieval unit.

26. The display device according to claim 25, wherein the corresponding-information retrieval unit extracts, on a basis of information on a position on a display screen of the display inputted in the display, a replacement path from the one or more replacement paths displayed in the display, and retrieves, from the data of the machining program, a movement command corresponding to the extracted replacement path.

27. A display device comprising:
a tool-movement-path calculator to calculate, on a basis of data of a machining program on which movement commands for a tool in a three-dimensional coordinate system are written, tool movement paths through which the tool moves in the three-dimensional coordinate system;
a path-replacement processor to replace, on a basis of the tool movement paths calculated by the tool-movement-path calculator and a predetermined index, consecutive tool movement paths with a replacement path;
a display to display one or more replacement paths generated by performing the path replacement processing one or more times; and
a corresponding-information retrieval unit to retrieve, from the one or more replacement paths, a replacement path corresponding to a movement command extracted from the data of the machining program displayed in the display,
wherein the display displays by highlighting the replacement path retrieved by the corresponding-information retrieval unit.

28. The display device according to claim 27, wherein the corresponding-information retrieval unit extracts, on a basis of information on a position on a display screen of the display inputted in the display, a movement command from the data of the machining program displayed in the display, and retrieves, from the one or more replacement paths, the replacement path corresponding to the extracted movement command.

29. A display device comprising:
a tool-movement-path calculator to calculate, on a basis of data of a machining program on which movement commands for a tool in a three-dimensional coordinate system are written, tool movement paths through which the tool moves in the three-dimensional coordinate system;
a path-replacement processor to replace, on a basis of the tool movement paths calculated by the tool-movement-path calculator and a predetermined index, consecutive tool movement paths with a replacement path;
a display to display the replacement path; and
a process-information retrieval unit,
wherein the tool-movement-path calculator divides the data of the machining program into arbitrary processes, calculates, on a basis of movement commands included in one of the arbitrarily divided processes, tool movement paths included in the one of the processes;
the path-replacement processor replaces, on a basis of the tool movement paths calculated by the tool-movement-path calculator and the predetermined index, consecutive tool movement paths included in the one of the processes with a replacement path;
the process-information retrieval unit retrieves, from one or more replacement paths generated by performing the path replacement processing one or more times, a replacement path corresponding to a processes extracted from processes displayed in the display; and
the display displays by highlighting the replacement path retrieved by the process-information retrieval unit.

30. A display device comprising:
a tool-movement-path calculator to calculate, on a basis of data of a machining program on which movement commands for a tool in a three-dimensional coordinate system are written, tool movement paths through which the tool moves in the three-dimensional coordinate system;
a path-replacement processor to replace, on a basis of the tool movement paths calculated by the tool-movement-path calculator and a predetermined index, consecutive tool movement paths with a replacement path;
a display to display the replacement path; and
a process-information retrieval unit,
wherein the tool-movement-path calculator divides the data of the machining program into arbitrary processes, calculates, on a basis of movement commands included in one of the arbitrarily divided processes, tool movement paths included in the one of the processes;
the path-replacement processor replaces, on a basis of the tool movement paths calculated by the tool-movement-path calculator and the predetermined index, consecutive tool movement paths included in the one of the processes with a replacement path;
the process-information retrieval unit retrieves from the data of the machining program one or more movement commands corresponding to a process extracted from processes displayed in the display; and
the display displays by highlighting the one or more movement commands retrieved by the process-information retrieval unit.

31. A display method comprising:
a tool-movement-path calculation step of calculating, on a basis of data of a machining program on which movement commands for a tool in a three-dimensional coordinate system are written, tool movement paths through which the tool moves in the three-dimensional coordinate system;
a path replacement step of replacing, on a basis of the tool movement paths calculated in the tool-movement-path calculation step and a predetermined index, consecutive tool movement paths with a replacement path; and
a replacement-path display step of displaying the replacement path in a display,
wherein, in the replacement-path display step, the replacement path is displayed in the display to be visually distinguishable in accordance with an angle between the replacement path and a predetermined reference vector.

32. A display method comprising:
a tool-movement-path calculation step of calculating, on a basis of data of a machining program on which movement commands for a tool in a three-dimensional coordinate system are written, tool movement paths through which the tool moves in the three-dimensional coordinate system;
a path replacement step of replacing, on a basis of the tool movement paths calculated in the tool-movement-path calculation step and a predetermined index, consecutive tool movement paths with a replacement path;
a replacement-path display step of displaying one or more replacement paths generated by performing the path replacement step one or more times in a display;
a movement-command retrieval step of retrieving, from the data of the machining program, a movement command corresponding to a replacement path extracted from the one or more replacement paths displayed in the display; and
a machining-program display step of displaying by highlighting the movement command retrieved in the movement-command retrieval step in the display.

33. A display method comprising:
a tool-movement-path calculation step of calculating, on a basis of data of a machining program on which movement commands for a tool in a three-dimensional coordinate system are written, tool movement paths through which the tool moves in the three-dimensional coordinate system;
a path replacement step of replacing, on a basis of the tool movement paths calculated in the tool-movement-path calculation step and a predetermined index, consecutive tool movement paths with a replacement path;
a replacement-path display step of displaying one or more replacement paths generated by performing the path replacement step one or more times in a display; and
a replacement-path retrieval step of retrieving, from the one or more replacement paths, a replacement path corresponding to a movement command extracted from the data of the machining program displayed in the display,
wherein, in the replacement-path display step, the replacement path retrieved in the replacement-path retrieval step is displayed to be highlighted in the display.
